(19) United States
(12) Patent Application Publication
(10) Pub. No.: US 2005/0025182 A1
(43) Pub. Date: Feb. 3, 2005

(54) Systems and methods using multiprotocol communication

(76) Inventor: Ala Nazari, Stockholm (SE)

Correspondence Address: SQUIRE, SANDERS & DEMPSEY L.L.P.;Two Renaissance Square, Suite 2700, 40 North Central Avenue, Phoenix, AZ, 85004-4498, US

(21) Appl. No.: 10/876,413

(22) Filed: Jun. 25, 2004

Related U.S. Application Data
(63) Continuation-in-part of application No. 10/838,500, filed on May 3, 2004.
(60) Provisional application No. 60/482,753, filed on Jun. 25, 2003.

(51) Int. Cl. H04J 3/22

(52) U.S. Cl. 370/469; 370/466

(57) ABSTRACT

A coupler for use with a provided terminal, the terminal being operative with a first network, the coupler including a monitor for monitoring the terminal to detect communication suitable for a second network and including a bridge for conveying the communication via a second network having a protocol not used with the first network.

### CROSS-REFERENCE TO RELATED APPLICATIONS

This application is a continuation in part of and claims priority to U.S. patent application Ser. No. 10/838,500 by Ala Nazari, filed May 3, 2004. This application also claims priority to U.S. provisional patent application Ser. No. 60/482,753 by Ala Nazari, filed Jun. 25, 2003, incorporated herein by this reference.

### FIELD OF THE INVENTION

Embodiments of the present invention relate to wireless communication.

### BACKGROUND OF THE INVENTION

Conventional wireless communication uses radio frequencies or infrared light for signals between communicating devices. Communication may be point to point to form a link. Multiple links may be organized to form a network. Networks may be formed among mobile devices (e.g., ad hoc networks, peer-to-peer communication) or formed with both mobile and fixed devices. Fixed devices (also called access points (APs)) may be coupled to a local area network (LAN) to form an infrastructure network with mobile devices. Communication generally conforms to standards such as IEEE 802.11 which specify operation of ad hoc networks (e.g., one or more links) and infrastructure networks (also called wireless local area networks (WLANs)). Operation includes communication according to layers of protocols (also called protocol stacks) including at least one physical protocol, media access control (MAC) layer protocol, and upper level protocols (e.g., TCP/IP, H.323). Devices that are capable of operating with a link or a network generally include a processor circuit programmed to support all functions of a protocol stack, and a transmitter.

Further deployment of devices capable of operating with a link or a network is impeded by relatively high power consumption by the processor circuit and transmitter of the device. Typically, the processor circuit and transmitter are active, consuming power, even when no link or network is available for communication.

WLAN technologies are gaining popularity because communication is in the unlicensed Industrial Scientific and Medical (ISM) band (e.g., from 2.40 GHz to 2.484 GHz, or from 5.725 GHz to 5.85 GHz) where communication is relatively inexpensive. However, threats to the global success of WLAN technologies include: (a) the possibility that widespread user demand will exceed the practical supply of efficient services; (b) the possibility that APs will be widely deployed without solving security and availability issues; (c) the cumbersome process of determining whether an AP is available for communication (e.g., detection and/or discovery); (d) limited deployment of roaming support, fair billing procedures, and attractive services; and (e) communication devices operable with only one network.

Conventional WLAN stations (STAs) are fully operational before being able to detect or discover access points or other stations. If an AP is detected or discovered, connectivity may be unavailable (e.g., the AP operator may require the user or station to have subscribed to a service), consequently no link is formed. If an AP is discovered to be available, local physical obstacles may from time to time impede communication. In a conventional WLAN station, after a link is established on one channel, the station is unable to monitor other channels, for example, for choosing a better channel.

Systems according to various aspects of the present invention, among other things, address the drawbacks discussed above, particularly those associated with detection and discovery, helping the user become aware of the availability of a suitable AP. Peer and/or AP detection and/or discovery may facilitate more widespread use of a WLAN for services provided (e.g., for profit) by a WLAN operator.

Without peer and/or AP detection and/or discovery, a prohibition against use of radio transmitters is difficult to enforce. Communication may be desired to be restricted to reduce the risk of interference with sensitive equipment as in hospitals and airplanes, or for other reasons imposed by site administrators (e.g., secure installations). For instance, it is difficult to enforce a prohibition on an airplane where two passengers may be playing computer games over a radio link without radio transmitter detection targeting point-to-point links.

Without communication devices capable of operation on more than one network, the introduction by competing network suppliers of new and expanded services, for example, services to initially narrow markets and services with initially narrow profit margins, may be slowed or dismissed as impractical.

### SUMMARY OF THE INVENTION

A coupler, according to various aspects of the present invention, is for use with a terminal. The terminal is operative with a first network. The coupler includes a monitor for monitoring the terminal to detect communication suitable for a second network and includes a bridge for conveying the communication via a second network having a protocol not used with the first network.

Another coupler, according to various aspects of the present invention, further includes a service advisor that determines whether communication via the second network is available.

Another coupler, according to various aspects of the present invention, includes circuitry formed on one substrate for communication with a terminal in a protocol of a first network and for communicating with a protocol of a second network.

A multiprotocol terminal, according to various aspects of the present invention, includes a terminal removably coupled to the coupler discussed above.

Another multiprotocol terminal, according to various aspects of the present invention, includes a housing, an application engine, and a coupler as discussed above wherein the application engine and the coupler are packaged within the housing.

A method for multiprotocol communication, according to various aspects of the present invention, is performed by a processor of a terminal. The method includes the following operations in any order: (a) monitoring a host or application engine coupled of the terminal for an attempt to communicate or on-going communication via a first network; (b) determining whether a second network is available; and (c) accomplishing communication for the host or application engine via the second network.

Another method for multiprotocol communication, according to various aspects of the present invention, is performed by a processor of a terminal. The method includes the following operations in any order: (a) monitoring a host or application engine coupled of the terminal for an attempt to communicate or on-going communication via a first network; (b) determining whether a second network is available; and (c) accomplishing communication for the host or application engine via the second network. Monitoring includes analysis of a signal provided by the host or application engine in response to a command by the processor.

Another method for multiprotocol communication, according to various aspects of the present invention, is performed by a processor of a terminal. The method includes the following operations in any order: (a) monitoring a host or application engine coupled of the terminal for an attempt to communicate or on-going communication via a first network; (b) determining whether a second network is available; and (c) accomplishing communication for the host or application engine via the second network. Monitoring includes detecting a signal provided by the host or application engine in the form of an AT command or response.

In the above methods, an attempt may includes an incoming telephone call or may include an outgoing telephone call. An attempt may further include continued communication suitable for a desired handover.

Another method for multiprotocol communication, according to various aspects of the present invention, is performed by a processor of a terminal. The method includes the following operations in any order: (a) monitoring a host or application engine coupled of the terminal for an attempt to communicate or on-going communication via a first network; (b) determining whether a second network is available; (c) accomplishing communication for the host or application engine via the second network; and (d) determining that the attempt is suitable for communication via the second network with reference to contents of a memory of the terminal.

Another method for multiprotocol communication, according to various aspects of the present invention, is performed by a processor of a terminal. The method includes the following operations in any order: (a) monitoring a host or application engine coupled of the terminal for an attempt to communicate or on-going communication via a first network; (b) determining whether a second network is available; (c) accomplishing communication for the host or application engine via the second network; and (d) determining that the attempt is suitable for communication via the second network with reference to data input by a user of the terminal prior to the attempt.

Another method for multiprotocol communication, according to various aspects of the present invention, is performed by a processor of a terminal. The method includes the following operations in any order: (a) monitoring a host or application engine coupled of the terminal for an attempt to communicate or on-going communication via a first network; (b) determining whether a second network is available; (c) accomplishing communication for the host or application engine via the second network; and (d) enabling communication via the second network in accordance with a command entered by the user of the terminal.

Still other systems, methods, and computer programmed products according to various aspects of the present invention include at least one or more of the above capabilities in combination with one or more functions for implementing a conference call, handling further incoming calls, notifying the user (or an application process of the terminal), and permitting the user to control which calls are subject to methods for multiprotocol communication.

### BRIEF DESCRIPTION OF THE DRAWINGS

Embodiments of the present invention may now be further described with reference to the drawing, wherein like designations denote like elements, and:

FIG. 1 is a functional block diagram illustrating operational relationships between a service advisor, other terminals, links, and networks according to various aspects of the present invention;

FIG. 2 is a functional block diagram of a service advisor of FIG. 1 in a first exemplary implementation;

FIG. 3 is a functional block diagram of a service advisor of FIG. 1 in a second implementation;

FIG. 4 is a functional block diagram of a service advisor of FIG. 1 in a third implementation;

FIG. 5 is a functional block diagram of a service advisor of FIG. 1 in a fourth implementation;

FIG. 6 is a functional block diagram of a portion of the receiver of FIG. 1;

FIG. 7 is a functional block diagram of a digital portion of the receiver of FIG. 1;

FIG. 8 is a functional block diagram of a service advisor apparatus according to various aspects of the present invention;

FIG. 9 is a functional block diagram illustrating operational relationships between a multiprotocol terminal, other terminals, links, and networks according to various aspects of the present invention;

FIG. 10 is a functional block diagram of a multiprotocol terminal of FIG. 9 in a first exemplary implementation;

FIG. 11 is a functional block diagram of a multiprotocol terminal of FIG. 9 in a second implementation;

FIG. 12 is a process flow diagram of a method according to various aspects of the present invention;

FIG. 13 is a functional block diagram of a coupler of FIG. 10; and

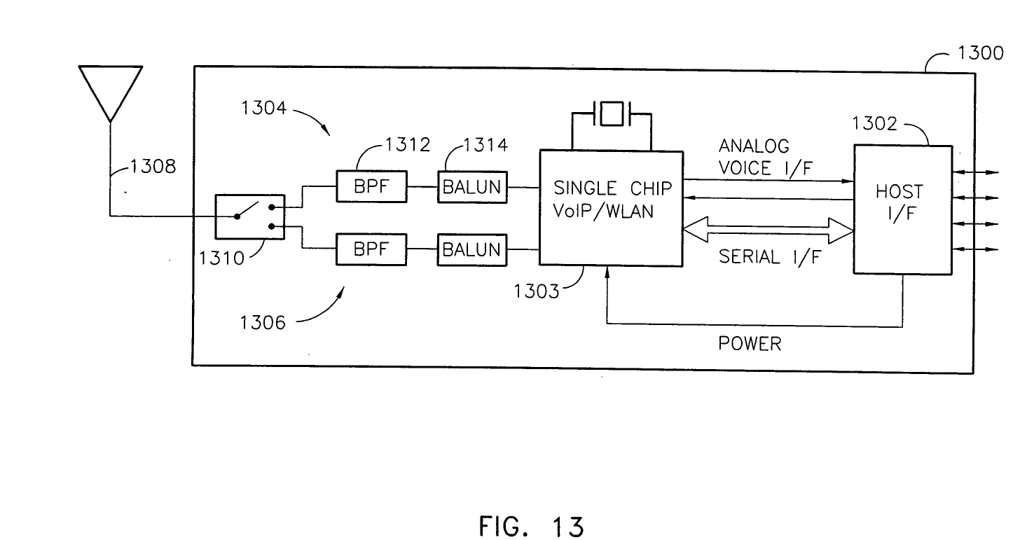

FIG. 14 is a functional block diagram of an integrated circuit of the coupler of FIG. 10.

### DETAILED DESCRIPTION OF THE PREFERRED EMBODIMENTS

The following description is provided to enable any person skilled in the art to make and use the invention, and is provided in the context of a particular application and its requirements. Various modifications to the embodiments will be readily apparent to those skilled in the art, and the generic principles defined herein may be applied to other embodiments and applications without departing from the spirit and scope of the invention. Thus, the present invention is not intended to be limited to the embodiments shown, but is to be accorded the widest scope consistent with the principles, features and teachings disclosed herein.

A service advisor according to various aspects of the present invention determines the availability of a service on one or more communication media (e.g., frequency bands, modulations, and protocols). In operation, a service advisor monitors and takes some action on the results of monitoring. Monitoring includes receiving communication and analyzing received communication to determine whether a service is available or not. Successful monitoring may be referred to as discovery in as much as a service that has been determined to be available is considered to have been discovered by the service advisor. Analysis may include whether received communication indicates that a transmitter with desired characteristics exists. Analysis may include ascertaining whether indicia of the received communication are within suitable ranges (e.g., match) particular parametric values stored in the service advisor (or accessible to the service advisor). Actions may include: (a) reporting to a user or to a process; and/or (b) operating a control of a process.

A service advisor generally performs functions (e.g., receiving) that may to some extent correspond to a limited subset of the functions performed by a communication device intended to participate in the service being monitored (herein called a terminal). Because the purpose of a service advisor differs from the purpose of a terminal, functions that may correspond between a service advisor and a terminal are generally implemented more simply in the service advisor because the service advisor generally does not meet all terminal specifications of the service being monitored and consequently may be implemented with fewer components both hardware and software and with wider performance margins. These differences generally permit a service advisor to be implemented at a fraction of the cost and size of a terminal.

In one implementation, a service advisor determines whether a service of a wireless local area network is available (e.g., suitable connectivity). Actions taken when such a service is available include reporting to a user (e.g., providing an annunciation, such as a notice to a user) and/or facilitating a wireless local area network connection.

In another implementation, a service advisor cooperates with a terminal to facilitate vertical and/or horizontal handover of an operating link without user intervention. Handover may be horizontal or vertical, where horizontal handover is generally within the same access technology (e.g., between different cellular telephone carrier networks) and vertical handover is not within the same access technology (e.g., handing over a cellular voice connection to a VoIP service).

A service advisor may include functions for one or more access technologies. For clarity of description, a service advisor having only WLAN (Wireless Local Area Network) access technology capability (and specifically IEEE 802.11 a-g) is discussed below. In alternate service advisor implementations, other single services may be monitored or multiple (horizontal and vertical) services may be monitored.

A service advisor, according to various aspects of the present invention, may assist users of WLAN services to identify geographical areas within which they are served by access points or are reachable by WLAN transmitters for links or networks. These may be APs or WLAN stations (collectively called terminals). The service advisor may receive communication (e.g., scan) for particular WLAN bands (e.g. 2.4 GHz and 5 GHz) and may inform its user whenever a transmitting WLAN device (AP or other) is found that exhibits desired characteristics.

The following glossary of terminology and acronyms serves to assist the reader by providing a simplified quick-reference definition. A person of ordinary skill in the art may understand the terms as used herein according to general usage and definitions that appear in widely available standards and reference books.

3rd Generation (3G) partnership project (3GPP): A grouping of international standards bodies, operators and vendors with the responsibility of standardizing the WCDMA based members of the IMT-2000 family.

Access control: The prevention of unauthorized usage of resources.

Access point (AP): An entity that has station functionality and provides access to a distribution service via a wireless medium for associated stations.

Ad hoc network: A network composed solely of stations within mutual communication range of each other via the wireless medium. An ad hoc network is typically created in a spontaneous manner. An ad hoc network typically has a limited temporal and spatial extent. Creating and dissolving the conventional ad hoc network is relatively convenient so as to be achievable by non-technical users. Ad hoc may refer to an independent basic service set (IBSS).

Association: An association service may be used to establish access point and/or station mapping (e.g., a relationship called an association). An association service may enable a station to access a distribution system service (DSS).

Authentication: An authentication service may be used to establish the identity of one station as a member of the set of stations authorized to associate with another station.

Basic service area (BSA): An area (e.g., logical or physical) within which members of a basic service set (BSS) may communicate.

Basic service set (BSS): A set of stations controlled by a single coordination function.

Basic service set (BSS) basic rate set: A set of data transfer rates that all the stations in a BSS may be capable of using to receive frames from the wireless medium. These data rates may be preset for all stations in the BSS.

Broadcast address: A unique multicast address that specifies all stations.

Channel: An instance of medium use for the purpose of passing protocol data units that may be used simultaneously, in the same volume of space, with other instances of medium use (on other channels) by other instances of the same physical layer with an acceptably low frame error ratio for errors due to mutual interference. Some physical layers provide only one channel, whereas others provide multiple channels.

Coordination function pollable: A station able to: (a) respond to a coordination function poll with a data frame, if such a frame is queued and able to be generated; and (b) interpret acknowledgments in frames sent to or from the point coordinator.

Coordination function: The logical function that determines when a station operating within a basic service set is permitted to transmit and may be able to receive protocol data units via the wireless medium. The coordination function within a basic service set may have one point coordination function and may have one distributed coordination function.

De-authentication: A service that voids an existing authentication relationship.

Directed address: An address in a frame that specifies a single recipient, not a broadcast or multicast address.

Disassociation: A service that removes an existing association relationship.

Distributed coordination function (DCF): A class of coordination functions where the same coordination function logic is active in every station in the basic service set whenever the network is in operation.

Global system for mobile communications (GSM): A digital cellular phone technology based on TDMA that is the predominant system in Europe, but is also used around the world. GSM phones use a Subscriber Identity Module (SIM) smart card that contains user account information.

Independent Basic Service Set (IBSS): A BSS that forms a self-contained network, and in which no access to a controlling access point is available.

Infrastructure BSS: An infrastructure may include one or more access points and stations, typically fixed in location.

Medium access control (MAC) management protocol data unit (MMPDU): A unit of data exchanged between two peer MAC entities to implement the MAC management protocol.

Medium access control (MAC) protocol data unit (MPDU): The unit of data exchanged between two peer MAC entities using the services of the physical layer.

Medium access control (MAC) service data unit (MSDU): Information that is delivered as units between MAC service access points (SAPs).

Mobile station: A type of station that uses network communications while in motion.

MPDU means a MAC protocol data unit.

Multicast: A medium access control (MAC) address that has the group bit set. A multicast MAC service data unit (MSDU) typically has a multicast destination address.

Network allocation vector (NAV): An indicator, maintained by each station, of time periods when transmission onto the wireless medium may not be initiated by the station whether or not the station's clear channel assessment function senses that the wireless medium is busy.

Protocol data unit (PDU): A unit of information transfer (e.g., a frame or packet).

PHY-SAP means physical layer service access point.

PIFS means point (coordination function) interframe space.

Public land mobile network (PLMN): Any cellular operator's network.

Point coordination function (PCF): A class of possible coordination functions in which the coordination function logic is active in only one station in a basic service set (BSS) at any given time that the network is in operation.

Portable station: A type of station that may be moved from location to location, but uses network communication while stationary.

Re-association: An association may be between an access point and a station. A re-association service enables an established association to be transferred from one AP to another AP. Transfer may be from one channel of an AP to another channel of the same AP.

SAP means service access point.

SIFS means short interframe space.

SME means station management entity.

Station (STA): Any device that includes an IEEE 802.11 conformant medium access control (MAC) and physical layer (PHY) interface to a wireless medium.

Station basic rate: A data transfer rate belonging to the extended service set (ESS) basic rate set that is used by a station for particular transmissions. The station basic rate may change dynamically as frequently as each medium access control protocol data unit (MPDU) transmission attempt, based on local considerations at that station.

Station service (SS): The set of services that support transport of medium access control service data units (MSDUs) between stations within a basic service set.

Time unit (TU): A measurement of time equal to 1024 μs.

Um: The air interface between the BTS and the MS in a GSM network.

Universal mobile telecommunications system (UMTS): The European implementation of the 3G wireless phone system, which is part of IMT-2000, provides service in the 2 GHz band and offers global roaming and personalized features. Designed as an evolutionary system for GSM network operators, multimedia data rates up to 2 Mbps are expected using the WCDMA technology.

Universal terrestrial radio access (UTRA): the air interface component of WCDMA.

Universal terrestrial radio access network (UTRAN): The UMTS radio access network comprising the RNC, Node B, and the air interface.

Unicast frame: A frame that is addressed to a single recipient, not a broadcast or multicast frame.

Uu: The air interface between the Node B and the MS in a UMTS network.

Wideband CDMA (WCDMA): A 3G technology that increases data transmission rates in GSM systems by using the CDMA air interface instead of TDMA. In the ITU's IMT-2000 3G specification, WCDMA has become known as the Direct Sequence (DS) mode. WCDMA may use a frequency division duplex mode (FDD) or a time division duplex mode (TDD).

Wireless medium (WM): The medium used to implement the transfer of protocol data units between peer physical layer entities of a wireless local area network, for example a particular frequency band (e.g., radio or light channel), modulation, and protocols.

Communication as discussed herein may include sending and/or receiving according to any protocol or protocol stack (e.g., wireless personal area networks (WPAMs) such as Bluetooth and wireless local area networks (WLANs) such as IEEE 802.11, WCDMA, GSM, 3G wireless, and 4G wireless). The terms sending, receiving, and communicating may refer to more or less functionality in the context of the protocol being discussed. For example, sending at a lower protocol layer may include modulating and transmitting and at a higher layer protocol may include formatting and framing. Receiving at a lower protocol layer may include detecting and demodulating and at a higher layer protocol may include requesting retransmission until a message is received without error.

In the following discussion, communication presumes consistency with IEEE 802.11. IEEE 802.11 is a wireless LAN standard developed by an IEEE committee to specify an “over the air” interface between a wireless client and a base station or access point. One purpose of the standard is to facilitate rapid deployment of wireless connectivity to automatic machinery and equipment or stations (e.g., fixed, portable (handheld), and mobile). The IEEE 802.11 standard defines a physical layer protocol and a media access control protocol layer for a WLAN. A typical WLAN setup includes one or more Access Points (AP) connected with a Distribution system (DS). Each AP transmits (e.g., broadcasts) and receives wireless information in a Basic Service Set (BSS) area. Any stations in the BSS area that have suitable authority may communicate with the AP using the protocols defined by IEEE 802.11 (a)-(g). IEEE 802.11 supports two topologies: (a) infrastructure BSS for a network having some or all fixed nodes; and (b) independent BSS for an ad hoc network. The infrastructure basic service set (BSS) is a building block of an IEEE 802.11 LAN. For instance, an infrastructure BSS may have three stations and one access point. Each station may have a fixed location, be portable, or be mobile. Each station sends data to another station through the AP. Before sending data, each station must become a member of the infrastructure BSS. Membership exists when the station is “associated” as discussed above. The association between a station and a BSS may be dynamic to accommodate stations asynchronously and without notice turning on, turning off, coming within range, and going out of range. If a station moves out of its basic service area, it may no longer communicate with other members of the same BSS and AP.

A service advisor, according to various aspects of the present invention, assists a user (or a process performed by a terminal) to communicate via one or more suitable and/or desirable networks. For example, an environment 100 includes a network 102, a terminal 112, a service advisor 110, a terminal 120, and a network 122. Network 102 has a plurality 104 of transceivers. Network 122 has a plurality 124 of transceivers. Networks 102 and 122 as well as transceivers 104, transceivers 124, and terminals 112 and 120 may be conventional. In the illustrated scenario, user 130 may desire to use terminal 120 with any available network via a suitable transceiver. User 130 refers to service advisor 110 after manual or automatic activation of service advisor 110. Automatic activation may follow from reception by service advisor 110 of sufficient radio communication or operative power (e.g., solar or RF energy). Service advisor 110 receives communication (e.g., radio or optical) from terminal 112, transceiver 106, transceiver 108, and transceiver 126. Service advisor 110 reports the availability of transceiver 112 (for an ad hoc link), network 102 (via transceivers 106 and 108), and network 122 (via transceiver 126). User 130 may then operate terminal 120 as desired to communicate with any of these available resources.

Service advisor 110 may discover services and report only those terminals, transceivers, access points, and/or networks that are available to user 130 and terminal 120. Availability may be reported in terms of services provided by the available entities and their resources. For example, network 102 may provide access to the World Wide Web, and/or particular subscription sites of the World Wide Web. Network 102, network 122, and/or terminal 112 may include data and peripheral resources (e.g., databases, printers, scanners, conventional telephone, FAX). The report of available services may therefore include the identity and/or description of the services of particular web sites and the identity and/or functions of particular data and peripheral resources. The report may include respective relative signal quality and/or estimated available capacity (e.g., signal strength, error rates, or congestion).

In one implementation, service advisor 110 receives communication consistent with IEEE 802.11, transceivers 104 are access points, and terminal 112 is a PC (e.g., a personal computer, workstation, laptop computer, or personal digital assistant). Networks 102 and/or 122 may be a WLAN. By contrast, terminal 120, which is not coupled to service advisor 110 in any way, may be any communication device. For instance, terminal 120 may be a cellular telephone and network 122 may be a conventional cellular telephone network. Service advisor 110 may report that a desired cellular transceiver 126 is available (e.g., providing desired services perhaps different from transceiver 128). Service advisor 110 may further report that voice over Internet (e.g., VoIP) telephony is available via transceivers 106 and 108, prompting user 130 to consider alternate forms of communication from terminal 120. The information provided by service advisor 110 may facilitate use of terminal 120 on either or both of networks 102 and 122.

Terminal 120 may be turned off or put in a low power mode of operation until a suitable report is provided by service advisor 110. As discussed below, because service advisor 110 is functionally simpler than terminal 120, operation of service advisor 110 instead of terminal 120 for the discovery of available services brings about a conservation of power (e.g., the sum of power used by service advisor 110 and terminal 120) and a reduction in radio transmission (e.g., because discovery may be accomplished without transmitting by service advisor 110).

A service advisor, according to various aspects of the present invention, consists of a receive-only communication device. In one implementation, service advisor 110 receives communication in a channel of interest; and determines that the communication is consistent with predetermined characteristics (e.g., is probably not noise, or is consistent with a desired protocol). Service advisor 110 may analyze packets of the received communication to determine the identity of transceivers, networks, and terminals. For instance, service advisor 110 may discover and report the NetId and/or BSSId of an access point. Still further, service advisor 110 may compare discovered NetIds and BSSIds with predetermined Netlds and BSSIds of interest to user 130 and report only those of interest. Interest may be indicated in particular NetIds and BSSIds and/or in ranges of NetIds and BSSIds (e.g., formed with conventional regular expression syntax).

Reporting as discussed above may be accomplished with any conventional annunciator. For example, any conventional vibratory, audio, or display annunciator may be used. Annunciation by the annunciator may include any conventional technique including coded vibrations, music, synthesized voice, coded illuminations, text (e.g., 16 character NetIds), and graphic images (e.g., for signal strength or congestion indications). Annunciations may be obtained from memory of service advisor 110, or in accordance with received communication (e.g., an announcement from the originator of the received communication).

A service advisor may perform discovery passively, that is with little or no transmitting. For instance, service advisor 110 may avoid conventional prohibitions on operation of radio transmitters when service advisor 110 does not include a radio transmitter. Receiving may include signal quality measurement (e.g., provide a received signal strength indicator); and may include reporting (e.g., transmitting) measurements for discovery of a suitable handover destination. Receiving may include a measurement of channel congestion (e.g., provide a channel utilization and/or an average error rate). Error rates may be observed in received communication of other links (e.g., snooping), or by transmitting and receiving for test purposes.

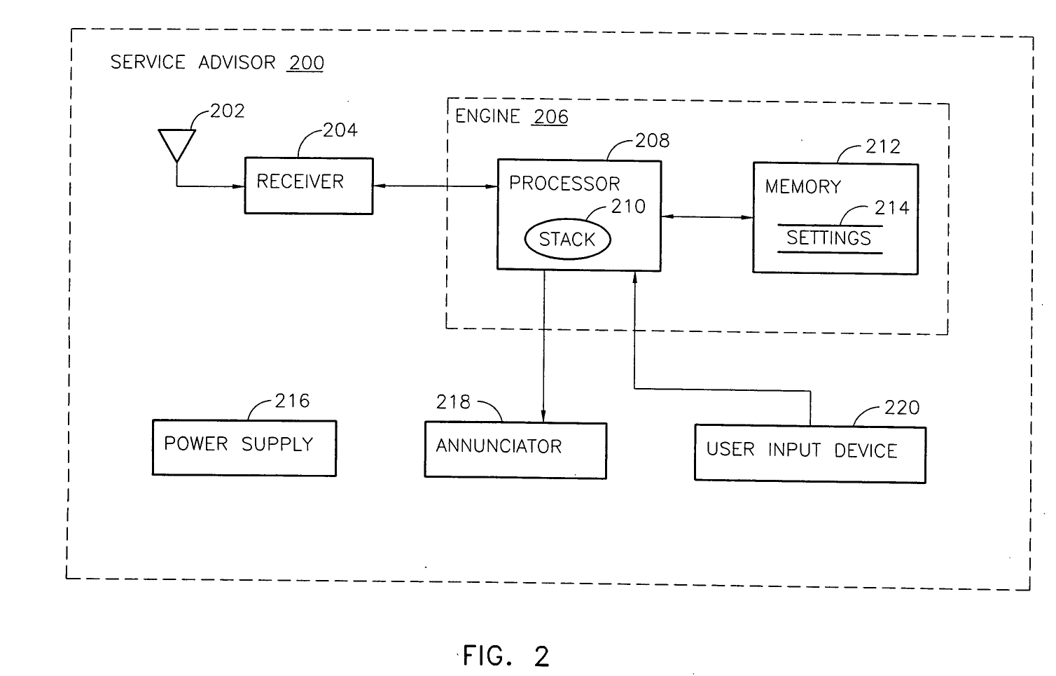

Service advisor 110 may be incorporated into any conventional object (e.g., a key chain or pen) or consumer electronics product (e.g., a garage door opener or watch). Alternatively, service advisor 110 may be implemented as a stand alone apparatus as in FIG. 2. Service advisor 200 of FIG. 2 includes antenna 202, receiver 204, engine 206, power supply 216, annunciator 218, and user input device 220. Engine 206 includes processor 208 performing a communication stack 210; and includes memory 212 storing settings 214. Conventional technologies for ISM communication may be used. As shown, antenna 202, receiver 204, power supply 216, annunciator 218, and user input device 220 are implemented using conventional structures and assembly technologies. In accordance with various aspects of the present invention, engine 206 may include a relatively low-power processing circuit having processing and memory capabilities customized for use in service advisor 200. In other words, lower power and smaller, less expensive service advisors may be constructed with engines having a subset of the types of conventional communication capabilities of somewhat similar engines in other consumer electronics products. For example, although a conventional wireless PDA includes an engine capable of performing a complete protocol stack for analyzing all packet formats defined for the WLAN it cooperates with, engine 206 is implemented with a protocol stack for analyzing a small subset of the packet formats defined for the same WLAN (e.g., only IEEE 802.11 beacon and probe packets in a preferred implementation).

Settings 214 may describe a scope for receiving, detecting, and discovering as discussed above. For example, settings 214 may identify only one service provider or one type of service provider to be reported. This limited form of service advisor may be suitable for distribution by or for the identified service provider to distinguish itself from competition. In another implementation, settings 214 includes any number of parameter values for specifying how receiver 204 and processor 208 cooperate (e.g., channels to be scanned, scan sequence and timing, thresholds for acceptable signal strength, protocols, packet formats, service provider identities, and/or decryption keys).

Power supply 216 may include a battery and/or energy conversion circuitry for solar, optical, or radio frequency energy. Power supply 216 may include one or more switches operable by the user and/or a timer for automatic operation (e.g., auto shut down after inactivity or discovery, periodic operation).

User input device 220 may include one or more switches and may further be arranged to cooperate with a display of annunciator 218. User input device may be operable to specify any values for determining settings 214 (e.g., by menu selections).

The user may provide input via device 220 to instruct the service advisor to perform continuous scanning (e.g., while the user is within the perimeter of an airport). The user may also configure the service advisor to scan for an AP that belongs to an operator to which the user is subscribed. The user may also instruct the service advisor to measure the signal quality of received WLAN communication. While using a WLAN device other than the service advisor, the user may desire to be advised of further detection and/or discovery by the service advisor. For example, the user may desire that the service advisor scan for other APs or channels, in case better quality channels become available.

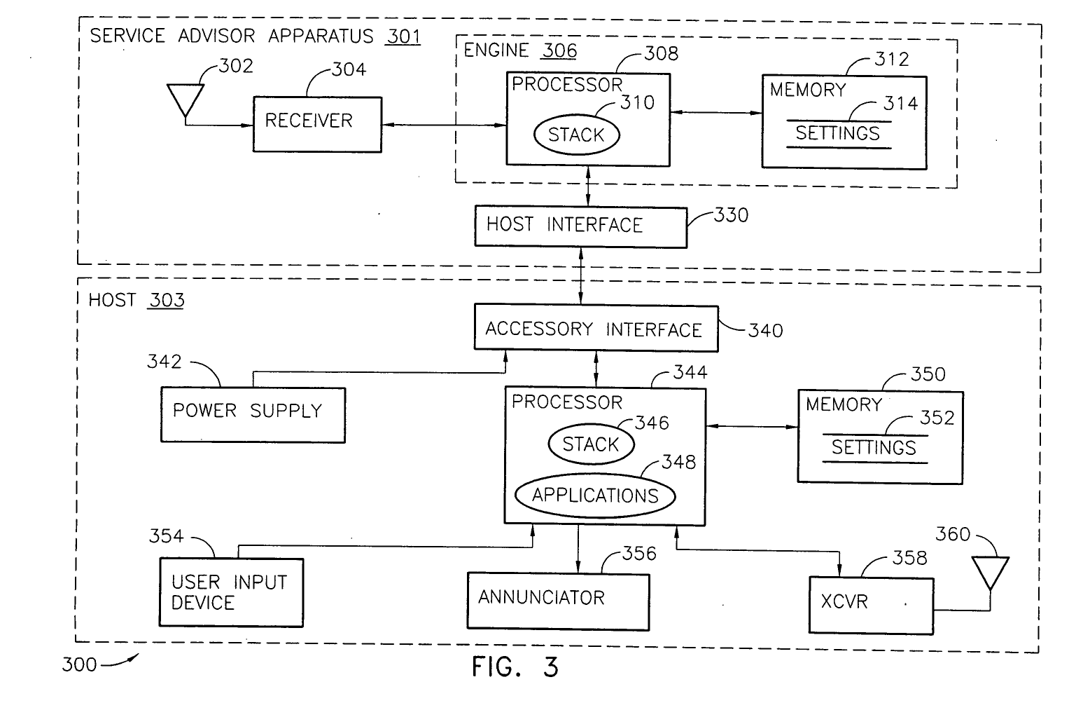

In a second implementation, service advisor 110 is implemented for use in combination with a host (e.g., any conventional consumer electronics product). The host provides power, annunciation, and user inputs; so that these functions may be omitted from the service advisor apparatus. For example, service advisor 300 of FIG. 3 includes service advisor apparatus 301 coupled to host 303. Service advisor apparatus 302 includes the following functional units having structure and functions corresponding to components described above: antenna 302 (202), receiver 304 (204), engine 306 (206), processor 308 (208), stack 310 (210), memory 312 (212), and settings 314 (214). Service advisor apparatus 302 further includes host interface 330 having any conventional structure and circuitry for compatibility with a conventional interface of host 303. Host interface 330 receives power for operation of service advisor apparatus, may include power control switches as discussed above, receives signals responsive to user inputs from host 303, and provides signals for operation of an annunciator of host 303.

Host 303 includes accessory interface 340, power supply 342, processor 344 that performs communication stack 346 and applications 348, memory 350 having settings 352, user input device 354, annunciator 356, transceiver 358, and antenna 360. In one implementation, host 303 comprises a conventional cellular telephone. In another implementation, host 303 comprises a WLAN capable PDA. In yet another implementation, host 303 comprises a pocket watch and transceiver 358 and antenna 360 are omitted. In still another implementation, host 303 comprises a general purpose computer (e.g., laptop computer) or peripheral (e.g., a printer).

In each implementation, host interface 330 of service advisor apparatus 301 is designed to be coupled to an accessory interface 340. Coupling may be as a tap or wye so that any conventional accessory designed for use with accessory interface 340 may be used simultaneously with coupling of service advisor apparatus 301 to host 303.

Settings 352 may be read by apparatus 301 to replace, modify, or supplement settings 314.

Access to and operation of host functions by service advisor apparatus 301 may be according to any conventional technique. In one implementation, serial signaling is used. Commands on the serial interface may conform to well known AT commands.

In addition to annunciation functions discussed above, service advisor apparatus 301 may issue commands to activate and/or control power supply 342 and/or transceiver 358. For example, after detection and/or discovery of a suitable service, apparatus 301 may activate power supply 342 to bring host 303 out of an off condition or a low power mode of operation (e.g., enabling full power operations because an available service has been discovered). In another example, after detection and/or discovery of a suitable service, apparatus 301 may activate or enable operation of at least a transmitter function of transceiver 358. Transmitting may be in accordance with stack 346 to confirm detection, discovery, or to conduct further detection and/or discovery of desired services.

In one implementation of cooperation of system 300, apparatus 301 continues to receive communications, detect, and discover available services; and report findings to host 303. In so doing, processor 346 may operate transceiver 358 to discontinue a first service and activate a second service in response to reporting (e.g., annunciation or control) by apparatus 301. For instance, terminating a cellular telephone call and initiating a VoIP telephone call may be initiated in response to such reporting that indicates a VoIP service has become available.

Stack 310 may be a subset of the capabilities of stack 346. Alternatively, stack 310 may operate on one network or protocol and stack 303 operate independently on another network or protocol. In this latter case, apparatus 301 performs an advisory function unrelated to operation of transceiver 358. For instance, if host 303 comprises a cellular telephone, apparatus 301 may temporarily use annunciator 356 to advise the user of WLAN services so that the user may operate a device (e.g., a PDA or laptop having WLAN capability) unrelated to the cellular telephone utilization.

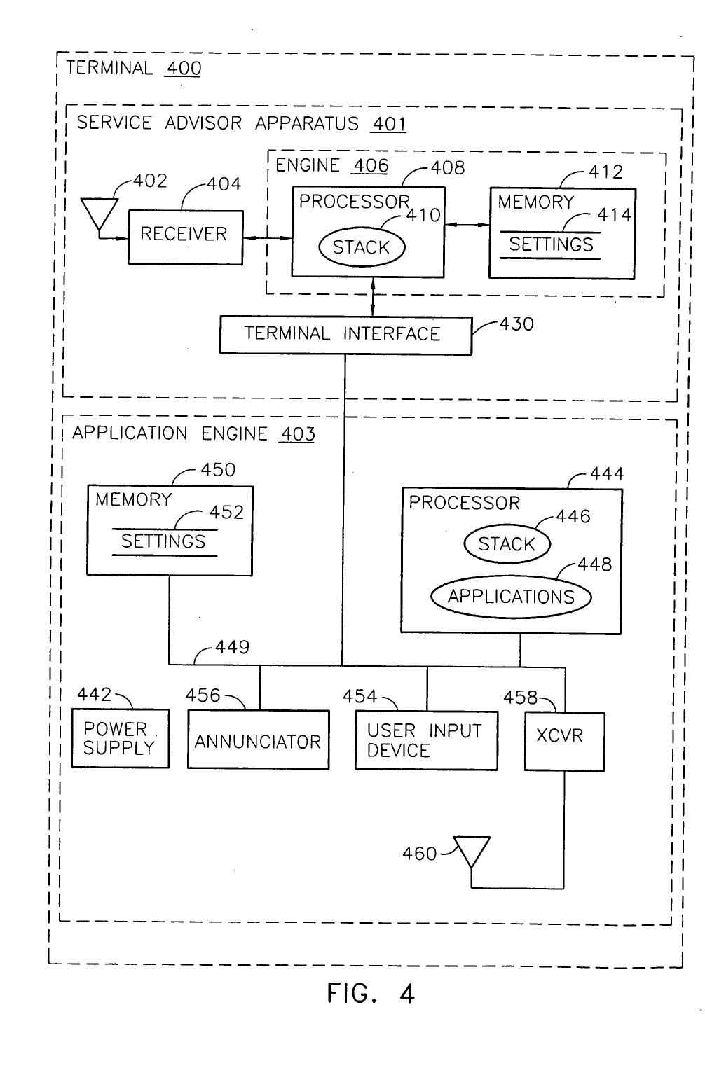

In a third implementation of a service advisor, the functions of a service advisor apparatus as discussed above are integrated with a terminal (e.g., any conventional consumer electronics product). The terminal provides power, annunciation, and user inputs; so that these functions may be omitted from the service advisor apparatus. For example, terminal 400 comprises a service advisor. Service advisor 400 of FIG. 4 includes service advisor apparatus 401 coupled to application engine 403. Service advisor apparatus 402 includes the following functional units having structure and functions corresponding to components described above: antenna 402 (302), receiver 404 (304), engine 406 (306), processor 408 (308), stack 410 (310) memory 412 (312), and settings 414 (314). Service advisor apparatus 402 further includes terminal interface 430 having any conventional structure and circuitry for compatibility with a conventional bus 449 of terminal 400.

Application engine 403 includes the following functional units having structure and functions corresponding to components discussed above: power supply 442 (342), processor 444 (344), stack 446 (346), applications 448 (348), memory 450 (350), settings 452 (352), user input device 454 (354), annunciator 456 (356), transceiver 458 (358), and antenna 460 (360). Application engine 403 further includes a conventional bus for coupling all functional components of the engine to the processor for program control.

When a service advisor (200, 300, 400) analyzes a packet over a WLAN channel that contains a IEEE 802.11 service set identifier (SSID), the service advisor may compare the SSID to one or more stored SSIDs to which the service advisor has access. Stored SSIDs may be included in settings as discussed above (e.g., any or all of 214, 314, 352 (e.g., an address book for an application 348), 414, and 452 (e.g., an address book for application 448)). If the comparison is successful (e.g., an exact or suitably close match), the service advisor may provide notice, provide reporting, or issue controls as discussed above.

A service advisor preferably does not include transmitter functionality. A preferred implementation, consists of a receiver and a processor that implements only a subset of a WLAN MAC (Media Access Control) protocol analysis. The receiver may comprise RF analog and digital circuitry (e.g., an RX-chain) and baseband (BB) logic. Furthermore, the RX-chain, BB layer, and MAC layer may be functionally optimized for identifying MAC packets of a limited number of particular types (e.g., IEEE 802.11 beacon and probe types). Optimization reduces the MAC layer to a fraction of the conventional MAC layer of a consumer electronics product having a communication device (e.g., host stack 346 or terminal stack 446). The service advisor may be designed for the limited purpose of identifying the subset of packet formats and ignore or discard others. Consequently, processing capability and memory capability for a service advisor are relatively less expensive than comparable functions in a host or terminal. Lower data rates simplify the RX-chain. Fewer error control functions typically apply to this subset of packet formats; consequently, BB logic is simplified. The user inputs discussed above may originate from a human user or from a process. Inputs may instruct the service advisor to start scanning for transmitters, to stop scanning, to perform periodic scanning under given values (e.g. scan every minute for 5 seconds and then rest).

Communication between service advisor apparatus 301, 401 and host 303 or application engine 403 may include serial commands of the type specified in the GSM 07.07 standard (e.g., well known AT commands) or equivalent for other standards. AT commands enable the service advisor apparatus to exercise control over the annunciator (e.g., display) and user input device (e.g., keypad) of the host or application engine. To this end, these AT commands might be used: Display control +CDIS, and Keypad control +CKPD.

Service advisor apparatus 301, 401 allows the user to store NetIDs of public WLAN operators to which the user is subscribed. To this end, service advisor apparatus 301, 401 may be configured to use a phonebook of the type stored on a conventional cellular phone. In this case, service advisor apparatus 301, 401 may use AT commands: +CPBR, +CPBF and +CPBW to read, find from, and write into the phonebook respectively.

A service advisor may be implemented with a set of integrated circuits (e.g., a chip set), assembled on a circuit board, and programmed with the MAC and annunciation logic functions discussed above. For example, service advisor apparatus 301, 401 may be responsive to an IEEE 802.11 =l command known as a MAC layer management function MLME-SCAN. request issued by host 303 or application engine 403 to initiate scanning for suitable SSIDs. The chip-set may include a radio chip (RF), a baseband and MAC chip, and a microprocessor (e.g., a standard rather than a custom processor, a low-power microcontroller preferred) that cooperate to implement service advising based on one or more standard protocols. The board may further include interface circuitry as discussed above (e.g., a serial or bus interface).

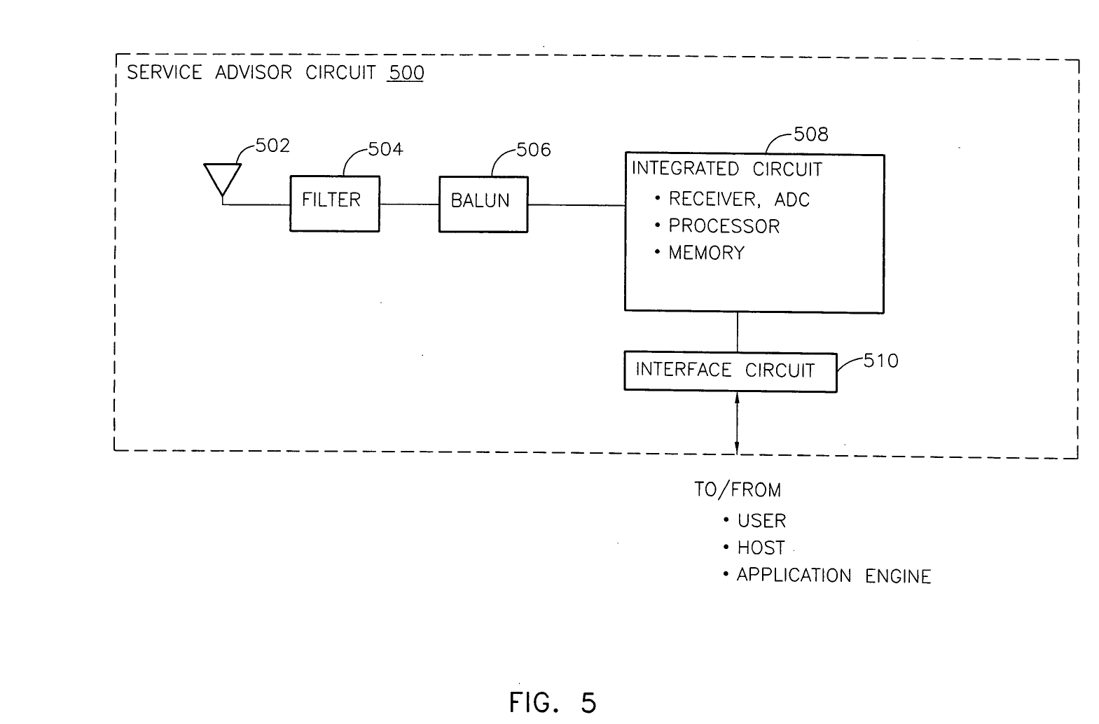

As discussed above, an integrated circuit substrate may be used to implement many functions of the service advisor 200, 300, 400 or service advisor apparatus 301, 401. For example, service advisor circuit 500 of FIG. 5 includes a scanner integrated circuit that implements functions of a receiver and an engine as discussed above. Circuit 500 includes antenna 502, filter 504, balun 506, scanner integrated circuit 508, and interface circuit 510. Circuit 500 may be assembled on a circuit board as discussed above.

Scanner integrated circuit 508 includes receiver analog and digital circuitry, an analog to digital converter (ADC) for converting received analog communication to digital for further analysis, a processor circuit (e.g., corresponding to processor 208, 308, 408), and a memory circuit (e.g., corresponding to memory 212, 312, 412). Memory may include conventional flash memory. Flash memory may store settings 214, 314, 414 including NetIDs as discussed above.

Interface circuit 510 supports the interface functions described above for one or more of the interface to the user (e.g., 110 to 130), to host 303, and to application engine 403. A multipurpose interface may provide greater economies of scale.

Service advisor circuit 500 or integrated circuit 508 may also automatically find the NetID of the AP if the user is subscribed to an operator running both the GSM (or other cellular standard) and the WLAN network. This scenario is likely because many cellular operators may also run public WLANs. Service advisor circuit 500 or integrated circuit 508 in this case extracts the NetID from IMSI (International Mobile Subscriber Identity) stored in the SIM card. The AT command +CIMI is used to retrieve IMSI. If service advisor circuit 500 is configured with the NetID, it will only discover APs having that NetID.

One example architecture for a service advisor circuit (also called a ScannerPlugIn) is shown in FIG. 5. The balun is an RF component that converts single ended signals from the antenna to fully differential signals for the radio receiver. It may be used as a separate (off chip) component as it is available from many suppliers, e.g. Murata, for the frequency ranges of interest to us, e.g. 2.4 GHz and 5 GHz ISM and UNII bands. The balun may also be fully integrated on chip in our solution. The crystal oscillator is a component used to provide a stable and very accurate reference frequency to the frequency synthesizer in the radio chip. The frequency of the crystal is determined by the frequency plan and the radio architecture adopted in the design of the radio chip. Our design could use a 20 MHz crystal oscillator device. Such a device is available from many suppliers of the market.

The service advisor may provide a smooth shift from AP-based communication to point-to-point communication. For example, if a PC and a dual-transceiver printer communicate via a WLAN AP, a service advisor may discover a point-to-point link is available from the user's terminal to the printer. The user may then shift to that link if reported quality is acceptable.

In one implementation, a service advisor extracts the SSID (Service Set ID) from a format of received communication (e.g., from a received beacon frame) and displays the SSID (or related information) to the user as a NetID (or service description).

Service advisor circuit 500 or integrated circuit 508 normally discovers all APs by listening on the different WLAN channels. However, it may be configured to discover APs serving a particular NetID. During the scanning process, if the SSID of the AP matches the pre-configures NetID, the user may be notified. Service advisor circuit 500 or integrated circuit 508 contains a very small flash memory enabling the user to easily configure the NetID(s) of interest. Configuration of the NetID may also be done during production of appliances that embed service advisor circuit 500 or integrated circuit 508. Service advisor circuit 500 or integrated circuit 508 may also measure the signal quality of the WLAN medium. This feature enables users to identify optimum location for their WLAN stations.

Service advisor circuit 500 or integrated circuit 508 implements the receiver chain of both the RF and IEEE 802.11 baseband as well as a small portion of the standard MAC. Only receiver components are required for the external front-end RF e.g., Balun and BandPass Filter (BPF). Neither antenna switch nor power amplifier (PA) is required. Furthermore, no WIFI device certification is needed, as service advisor circuit 500 or integrated circuit 508 is passive. The baseband implements the receiver chain of IEEE 802.11 g that consists of OFDM RX chain and CCK RX chain.

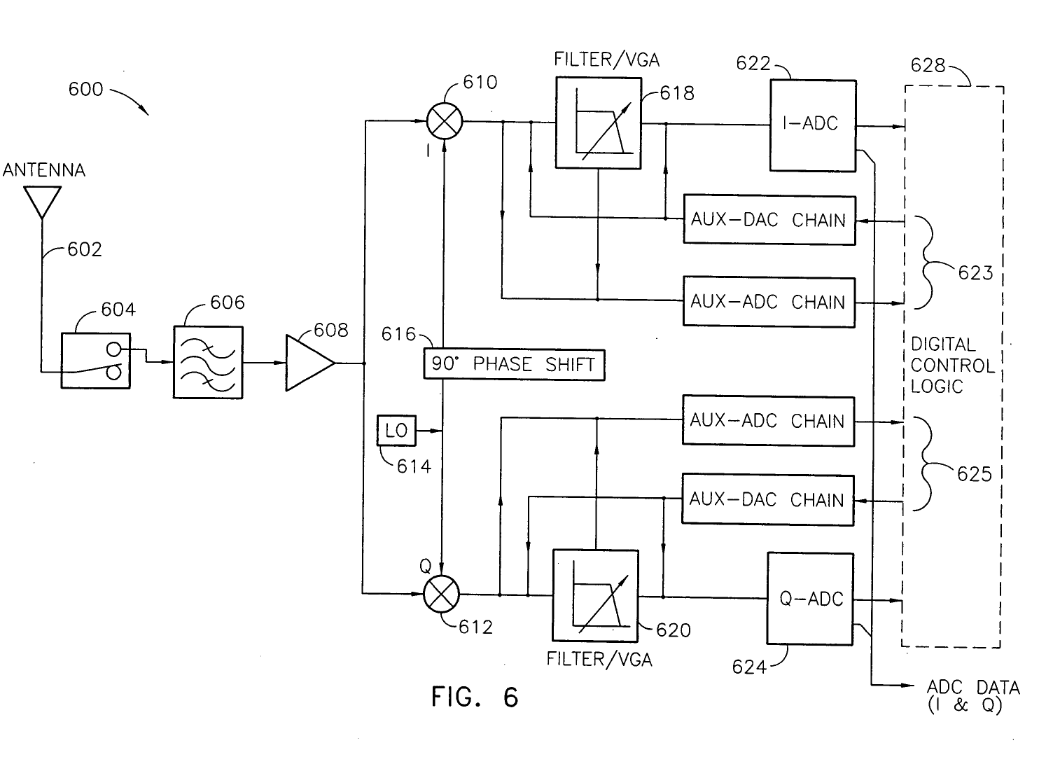

A receiver, according to various aspects of the present invention does not include one or more of channel equalization, full soft decision Viterbi for forward error correction, and intermediate frequency (IF) circuitry. These simplifications are consistent with processing only beacon and probe packets (e.g., lower base rate set). For example, a zero-IF offset cancellation receiver circuit 600 (also called a baseband (BB) circuit) of FIG. 6 includes antenna 602, antenna switch 604, band pass filter 606, low noise amplifier 608, mixers 610 and 612, local oscillator 614, 90-degree phase shifter 616, filter and/or variable gain amplifiers 618 and 620, analog to digital converters 622 and 624, and digital control logic 628 providing digital feedback controls for ADCs 622 and 624 with circuits 623 and 625. By operation of mixers 610 and 612, I and Q phased signals are provided without intermediate frequency (IF) processing circuits. Receiver circuit 600 may further provide a received signal strength indicator signal (RSSI) in any conventional manner (not shown). Antenna switch 604 may be used for initialization of receiver circuits (e.g. with no signal input) or may be omitted.

After conversion of received signals to digital format, digital control logic, firmware, and software (e.g., implemented in an engine 206, 306, 406) cooperate with receiver circuit 600 to accomplish detecting, analyzing packet formats, discovering APs and ad hoc terminals, and reporting as discussed above. For example, digital receiver 700 operates in one implementation as part of receiver 204, 304, 404; and in another implementation as part of engine 206, 306, 406. In either case, signal processing may be accomplished with any mix of special purpose circuits (e.g., having the same functional names) and general purpose circuits (e.g., logic and stored program controllers). Received communication (RX) in digital form is processed by a received communication digital filter (RX Dig. filter), is subject to automatic gain control (AGC), fast Fourier transformation (FFT), decision feedback equalization (DFE), and cyclic redundancy checking (CRC) prior to analysis of frame contents by the physical layer software and MAC layer protocol analyzer. Digital receiver 700 may be implemented with conventional software and circuitry (e.g., an 8-bit microcontroller).

According to various aspects of the present invention, a service advisor 200, 300, service advisor apparatus 301, 401, service advisor circuit 500, or integrated circuit 508 may discover services that use any of several horizontal and/or vertical access technologies. Further, a service advisor may facilitate vertical and/or horizontal handover for a terminal to which the service advisor is coupled. The service advisor may be attached as an accessory to the terminal or integral to the terminal for communication between the terminal and the service provider.

Handover is conventionally preceded by measurements taken typically by the terminal (e.g., also called a mobile station). For GSM, CDMA and UMTS networks, the mobile station typically takes measurements (e.g., of received signal strength) from signals received from its serving cell and signals received from neighboring cells. These measurements are then reported to the serving cell (e.g., on an event driven or regular basis). The network (e.g., the serving cell) may decide whether handover is desired or not. The network then coordinates and performs the handover procedure. For WLANs, the mobile station typically makes the measurements, determines whether handover is desired, and coordinates and performs the handover procedure.

Conducting measurements is problematic particularly for radio technologies operating in continuous transmit/receive mode (e.g., WLAN, CDMA and WCDMA-FDD). For instance, all the radio frames of dedicated physical channels in WCDMA-FDD must be filled. Therefore, it is difficult for the mobile station to use its transceiver (e.g., 458) to take measurements on other radio technologies (e.g., UTRA carriers) at the same time as receiving and transmitting on the current carrier.

According to various aspects of the present invention, a terminal operating on a current access technology (e.g., a current channel) cooperates with a service advisor operating on any of several different access technologies (e.g., different channels of the same or different access technologies). The terminal may rely on measurements, taken by the service advisor, for coordinating handover. The service advisor may take measurements using a wide-band receiver, configured, in turn, for each radio technology suitable for the handover. The terminal transceiver may engage compressed mode to create idle gaps in transmission on the current channel, using any conventional technique, to facilitate measurements performed in the gap by the service advisor. For example, conventional puncturing, spreading factor reduction, and scheduling using restrictions on transport format combinations used in a frame may be used to create gaps in transmissions on the current channel. The service advisor may determine that a handover is desirable and so indicate to the terminal.

A terminal may also cooperate with a service advisor to accomplish handover in less time than taken with conventional techniques. For example, at any suitable time (e.g., after a link-layer handover), the terminal may issue a solicitation for conventional agent advertisements. Agent advertisements may be received (and suitable services discovered) sooner than by awaiting the first unsolicited advertisement in each desired radio access technology. In this way, delays associated with conventional movement detection are reduced or eliminated.

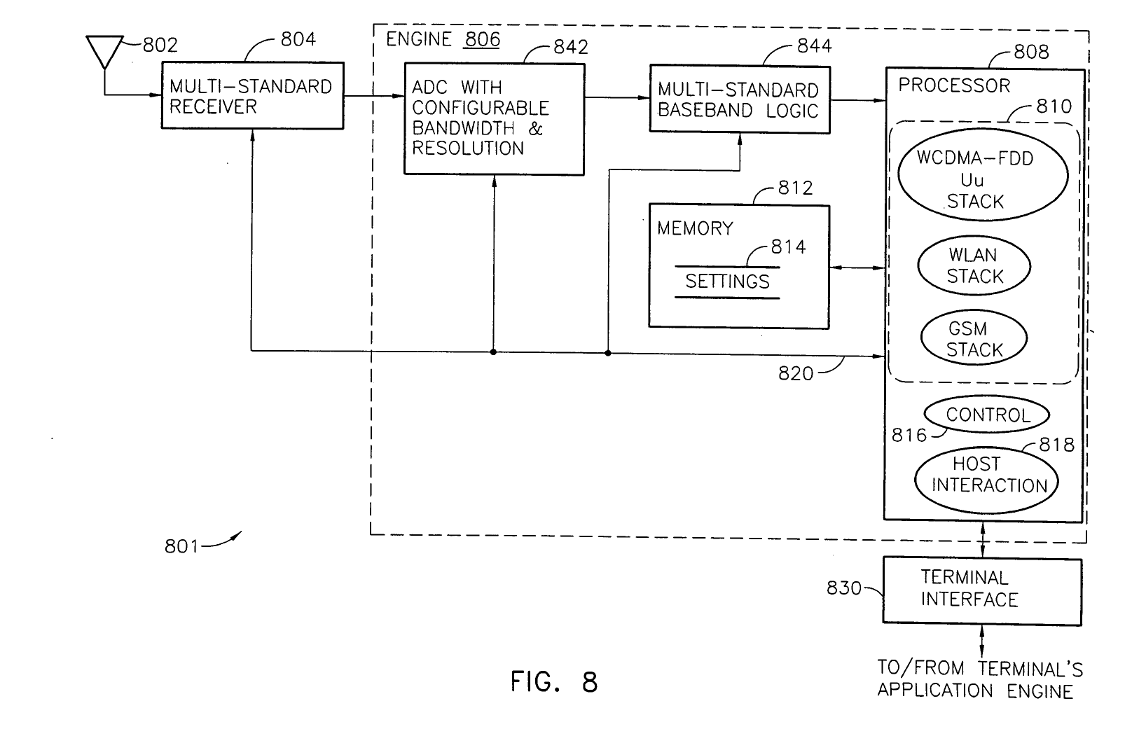

In an exemplary implementation, service advisor apparatus 801 of FIG. 8 discovers services using any of several horizontal and/or vertical access technologies and facilitates vertical and/or horizontal handover as discussed above. Functions of service advisor apparatus 801 will be discussed with reference to its use in place of service advisor apparatus 401 of FIG. 4 to provide an improved terminal. In such an improved terminal, transceiver 458 and processor 444 may operate in parallel with operations performed by service apparatus 801. Processors 444 and 808 may communicate in any conventional manner to suitably share resources (e.g., air time, bus 449 traffic, power from supply 442) and avoid inefficient operation of either processor.

Service advisor apparatus 801 includes antenna 802 suitable (in turn) for each access technology, multi-standard receiver 804, engine 806, and terminal interface 830. Engine 806 includes analog to digital converter 842, multi-standard baseband logic 844, memory 812 having settings 814, and processor 808 having plural stacks 810, control process 816, and host interaction process 818. Processor 808 controls receiver 804, ADC 842, BB logic 844 via control bus 820. A conventional microcontroller may be used for processor 808.

Engine 806 may employ layered re-entrant software and configurable circuitry to receive and analyze communication from plural access technologies with a minimum of special purpose software and circuitry. For example, software may be implemented with components having interfaces between the components, object-oriented design, and responsibility for processing functions arranged in layers between interfaces.

Stacks 810 may include any number of processes for any number of access technologies. In the illustrated implementation, stacks 810 include a process for a WCDMA-FDD Uu stack, a process for a WLAN stack, and a process for a GSM stack. Conventional software technology may be used to implement each stack. When BB logic 844 is providing received communication from a first access technology (e.g., WLAN) results of BB logic may be stored in a suitable queue for the WLAN stack. Queues may supply each process with information from BB logic 844 and processor 808 may be analyzing received communication using multi-threaded processes so that discovery with respect to any access technology may be made (and prioritized) according to availability of processing resources.

Receiver 804 may include the functions and structures of receiver circuit 600 and digital receiver 700 as discussed above and adapted using conventional control circuits for operation on each access technology as directed by processor 808. Band pass filters (e.g., 504) and baluns (e.g., 506) for each access technology may be integrated onto the substrate of a service advisor apparatus. In an alternate implementation, antenna 802 may be co-packaged with front-end components not suitable for packaging with a single chip integrated circuit implementation of apparatus 801. In another alternate implementation the antenna used by the terminal's application engine may be coupled for use by the service advisor apparatus.

Settings 814 may include a set of settings for each of several predetermined configurations.

In operation, control process 816 may perform a loop. In each iteration, process 815 recalls a suitable set of settings 814 from memory 812; assures that the set of settings is properly invoked on the configurable circuits of antenna 802, receiver 804, ADC 842, and BB logic 844; and couples a suitable stack 810 to BB logic 844 for service discovery and/or measurements. Results from each stack may be queued for reporting to the terminal through host interaction process 818.

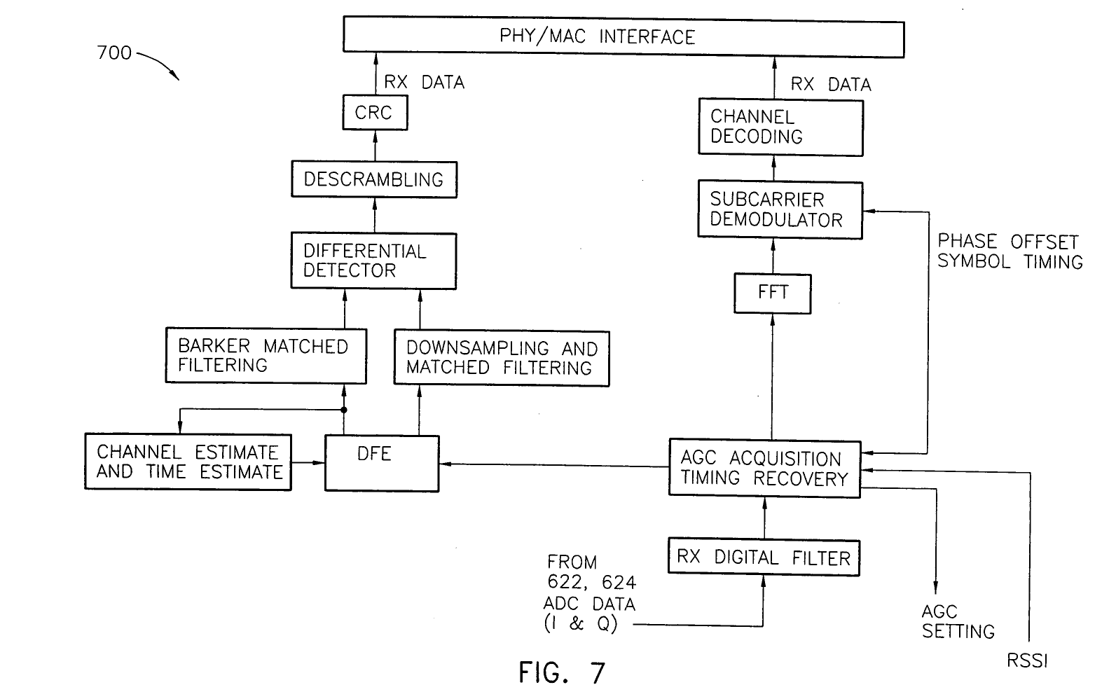

Host interaction process 818 may report services discovered by each stack as discussed above with reference to other service advisor implementations (e.g., FIGS. 2-7). Host interaction process 818 cooperates with terminal interface 830 to provide communication between engine 806 and the terminal's application engine (not shown). Any conventional interface may be used including an interface as discussed above with reference to interface 430. Service advisor apparatus 801 may communicate with the terminal's application engine using a low rate serial interface (e.g., a conventional Universal Asynchronous Receiver Transmitter (UART)).

Service advisor apparatus 801 may be implemented in a service advisor circuit of the type described with reference to circuit 500. Consequently, the multiple access technology functions of service advisor apparatus 801 may be incorporated into any service advisor discussed herein. Annunciations for each access technology may have a respective common form (e.g., text, tones, graphics, narration of speech). For example, a woman's voice may be used to announce all discovered cellular telephone services and a man's voice may be used to announce all discovered wireless network services (e.g., VoIP).

Particular handovers may be performed as authorized by input from the user. User input may be stored as preferred settings. In this way, nuisance handovers may be avoided and handovers from low quality inexpensive services to more expensive services may be avoided in circumstances as desired by the user.

In operation, service advisor apparatus 801 may provide information describing discovered services in a manner suitable for handover decision making by the terminal's application engine. Such information may be provided as requested by the terminal's application engine; and may be selected and/or ordered. Ordering may be based on any combination of identity of service operators, signal quality (e.g., “best”, lowest error rate, least congested), service type (e.g., protocol, access technology). Selection may be based on any logical combination of preferred access technology, preferred operator, preferred signal quality, minimum required service (e.g., bandwidth, capacity, error rate, effective data rate). Examples of such information are described in Table 1. The signal quality for each access technology may be based on physical layer measurements and on criteria specified by the associated access technology standards. The mobile operator may be identified by PLMN Identity in case of UMTS and GSM or Net Identity in case of WLAN.

TABLE 1

| Information | Organization |
|---|---|
| Identification of service | Grouped by access technology; |
| operators of discovered | Ordered by signal quality to identify a “best service”, “best cell”, |
| services | and/or “best channel”; |
| | Ordered by signal quality for each available service, cell, and |
| | channel; |
| | For selected set of one or more service operators and/or selected |
| | set of one or more services; |
| Identification of access | Grouped by operator; |
| technologies of | Grouped by access technology; |
| discovered services | Ordered by signal quality to identify a “best service”, “best cell”, |
| | and/or “best channel”; |
| | Ordered by signal quality for each available service, cell, and |
| | channel; |
| | For selected set of one or more service operators and/or selected |
| | set of one or more services; |
| Identification of | Grouped by access technology; |
| discovered peers | Ordered by signal quality to identify a “best service”, “best cell”, |
| | and/or “best channel”; |
| | Ordered by signal quality for each available service, cell, and |
| | channel; |
| | For selected set of one or more service operators and/or selected |
| | set of one or more services; |
| Notice of change in signal | Grouped by operator; |
| quality | Grouped by access technology; |
| | Ordered by signal quality to identify a “best service”, “best cell”, |
| | and/or “best channel”; |
| | Ordered by signal quality for each available service, cell, and |
| | channel; |
| | For selected set of one or more service operators and/or selected |
| | set of one or more services; |
| Broadcast system | May include UMTS SIBs (system information blocks), GSM system |
| information on the current | information received on a broadcast channel (e.g., BCCH), |
| access technology or any | information from WLAN beacon messages |
| specified one or set of | |
| services, cells, or | |
| channels | |
| Status on a cell and/or | May indicate that a cell is available for service or barred due to |
| channel in terms of | high traffic load or estimated network conditions in case of |
| service effectivity, | WLAN; |
| availability, and | |
| conditions | |
| Available PLMNs in the | For example, used to support roaming |
| current wireless | |
| environment with | |
| associated access | |
| technologies and signal | |
| quality | |
| Parameters suitable for | May include scrambling code and UTRA carrier in case of |
| tuning to the found best | UMTS; broadcast carrier for GSM; and channel number for |
| cell and/or channel; | WLAN; May include a time offset of the new cell, enabling the |
| | terminal to immediately synchronize to the new cell; |
| Measurements (raw, or | Data may be filtered on some important intermediate scanning |
| processed) | results. Filtering may follow thresholds supplied by the terminal |
| | or on a preconfigured standard that defines thresholds (e.g., |
| | specified in the broadcast system information) |

Service advisor apparatus 801 may perform scanning in two different modes: (a) continuous mode where service advisor apparatus 801 supplies the terminal's application engine with continuous information about best cells, channels, and access technologies in terms of system information, service, signal quality (e.g., network conditions); and (b) one-time scan where service advisor apparatus 801 performs scanning for the best cell and/or access technology only one time upon request.

The terminal's application engine may command service advisor apparatus 801 to operate in continuous low power scanning mode looking for better cells and/or access technologies having better signal quality, suitable network conditions, and/or lower transmission cost, enabling the terminal's application engine in the idle state to do cell and/or channel reselection or together with the network to decide whether to do handover when the terminal's application engine is operating in a connected state. To reduce battery power consumption by the terminal, continuous scanning may run periodically at time intervals. Different time intervals may be defined based on supported service and power utilization requirements. The terminal's application engine may dictate the power level (e.g., low, medium, or high) and service advisor apparatus 801 may calculate suitable scanning time intervals accordingly. When in the idle state, low power scanning is preferred. However, in the connected state with an established voice session, the high power mode is preferred.

Service advisor apparatus 801 may conduct prioritized scanning where the terminal's application engine may dictate, based on requested service (e.g., packet switched, or circuit switched), the order of the access technologies to be scanned; or the order of parts of a frequency band to be scanned. The terminal's application engine may also specify the bands of interest, for example, (a) 900, 1800, or 1900 MHz for GSM; (b) 1900 or 2000 MHz for UMTS; and/or (c) the range of WLAN channels on the 2.4 GHz band.

Service advisor apparatus 801 may store PLMNs to be monitored (or PLMNs discovered) and their associated access technologies with allocated carriers (also called service operators). This information is dynamic and may be learned from prior scanning for selected PLMNs or may be based on broadcast system information (e.g., SIB 11 of UMTS) that may specify the neighbor cell list. When the terminal's application engine selects the PLMN and calls service advisor apparatus 801 to scan for best cells or access technologies operated by a specified PLMN, service advisor apparatus 801 may first consult its stored PLMNs (e.g., a database) to find associated access technologies and their carriers so as to scan these access technologies and/or carriers. This technique may speed up the scanning process significantly.

The terminal's application engine may also dictate when the scanning results may be reported. For example, reporting may be after: (a) the end of the whole scanning process; (b) the scanning of each access technology, cell or channel; (c) finding the mobile operator; and/or (d) finding the best access technology, cell, and/or channel. The terminal's application engine may stop service advisor apparatus 801 scanning at any time.

Service advisor apparatus 801 scanning capabilities may assist the terminal's application engine to efficiently and seamlessly conduct scanning and measurements for handover without disturbing existing user's sessions. The handover decision may be made by the terminal's application engine and network as opposed to the service advisor apparatus 801. However, service advisor apparatus 801 may speed up the handover process by reporting requested measurements and parameters for a successful handover.

Service advisor apparatus 801 provides several advantages for various radio access technologies. For 3G, service advisor apparatus 801 scans for the best cell and supplies the terminal's application engine with all the parameters required to tune to that cell. In case of hard handover, it may make the ineffective compressed mode superfluous. For example, service advisor apparatus 801 may conduct inter-frequency and inter-access technology cell search and measurements while the main WCDMA-FDD transceiver transmits and/or receives user data.

Service advisor apparatus 801 may be implemented in 0.18 micron CMOS integrated circuit technology with a power conservation architecture (e.g., as for a suitable integrated circuit of the type described with reference to IC 508). As opposed to an implementation involving a chipset or chipsets for each of several access technologies, the integration of service advisor apparatus 801 on a single substrate provides the following beneficial results: (a) lower power consumption; (b) quicker initialization and warm up; and (c) faster identification of available services. Lower power consumption may be due in part to omission of chip-to-chip communication. Initialization and one-time warm up of a single substrate may be accomplished in about 700 msec. as opposed to warm up of that may be required before each use of each different access technology. Service advisor apparatus 801 may discover services, peers, operators, links, and networks faster because scanning may be limited to stored information about PLMNs and their associated access technologies. For example, the most desirable services, cells, channels, links, networks, peers, and/or operators may be discovered by priority scanning (e.g., trial and error from an ordered list).

Service advisor apparatus 801 may be used for cell to cell handover.

Service advisor apparatus 801 may improve UTRAN performance by making the Immediate Cell Evaluation procedure for Random Access Channel (RACH) possible. In one implementation, the terminal is “camped on” the best cell before sending RACH bursts to UTRAN. Later, the terminal may ramp up the RACH transmission power by an increment for each burst. If the terminal sends bursts to the wrong Node-B that is closer than the serving Node-B, severe interference could be introduced because the RACH burst is addressed to the serving Node-B far away and the received signal power at the nearby Node-B may be high. This could occur if the terminal has moved to a new cell and cell reselection has not been accomplished yet. To avoid this, the terminal may check if it's serving cell is still the best. Immediate Cell Evaluation takes time when the terminal measures the signal quality (e.g., strength) of the neighboring cells and compares these measurements to the signal quality of the serving cell. The neighbor cell list may be included in the system information SIB 11. The procedure may consume even more time when cell reselection is to take place. Existing 3G terminals do not support this feature and 3GPP has left this issue unsolved. Service advisor apparatus 801 with its continuous cell search on intra-frequency neighboring cells may avoid Immediate Cell Evaluation as discussed herein.

For WLAN, the lengthy channel scanning required for mobility that could take seconds may be skipped and the terminal's application engine may momentarily get all the information required to immediately connect to the new WLAN cell, including channel number, content of various rate sets (basic, supported and operational), supported standard (IEEE 802.11b, or mixed IEEE 802.11b and 11g), QoS support, and type of security supported.

Service advisor apparatus 801 may measure network conditions of WLAN channels using virtual sensing based on monitoring the NAV (Network Access Vector) parameter exchanged in various WLAN frames. Service advisor apparatus 801 may scan for the best WLAN cell (e.g., where “best” herein means having signal quality and/or available capacity exceeding minimum desired thresholds; and/or having channel access delay less than a maximum desired threshold).

Service advisor apparatus 801 may started scanning with non-overlapping sets of channels.

Service advisor apparatus 801 may store discovered Net IDs and their associated channels in a database in any conventional memory device accessible by service advisor apparatus 801. Scanning may be consistent with such a database so as to more quickly discover and report services of interest. Service advisor apparatus 801 by using stored information describing the current and desired environment and PLMNs provides much faster cell search than any standard GSM transceiver. Conducting inter-access technology pre-handover measurements (e.g., for WCDMA) while the mobile terminal's application engine is currently connected via GSM, may require modifications on existing GSM chipsets particularly the timing of the synthesizer because the time required to do cell search on WCDMA is more than the time for doing cell search on other GSM broadcast carriers. While GSM is used for communication, service advisor apparatus 801 may scan the WCDMA medium and receive the latest broadcast system information including any predefined configurations (e.g., as included in SIB 16). The handover process from GSM to UTRAN may be quicker because this information is received in a timely manner and/or is applied to improve scanning.

For mobile IP, service advisor apparatus 801 speeds up the movement detection of the Mobile Node by monitoring the condition of the used medium and notifies the Mobile IP layer when significant changes have occurred. Service advisor apparatus 801 may also recommend a better channel than currently available in the wireless environment. The Mobile IP may broadcast an Agent Solicitation message on the new channel forcing available Mobile Agents to respond with Agent Advertisement message. If network prefix of the new Foreign Agent is the same as the network prefix of current Foreign Agent, the Mobile Node may perform handover to the new channel and register with the new Foreign Agent.

In an alternate implementation, service advisor apparatus 801 may also be extended with capability to detect an Agent Advertisement message enabling service advisor apparatus 801 to detect Mobile IP movement without assistance from the terminal's application engine. In one implementation, a “make before break handover” is accomplished.

From the protocol point of view, a service advisor according to various aspects of the present invention includes a multiple stack engine, where each stack may be dedicated to an access technology and contain the functions required for measurements for that technology. For example, each stack may be a set of objects having a common interface to a control process (816) and a host interaction process (818).

In one implementation, service advisor apparatus 801 operates one access technology at a time. By operating only one access technology at a time, most service advisor functional blocks may be shared among the supported access technologies. For instance, the baseband logic for several access technologies may share functional blocks for equalization, error checking, and convolutional decoding. This implementation includes only one configurable ADC and shared analog receiver circuitry (e.g., a common analog baseband circuit). Before such a service advisor apparatus starts scanning one access technology, the parametric variables (e.g., configuration settings) of the circuits that implement the shared functions may be set with values specific to that access technology.

A service advisor apparatus may operate in an idle mode for one or more access technologies. By using idle mode, only a subset of the circuitry for an RX-chain of a terminal of each access technology need be implemented. For example, received information for discovery and measurements for the WCDMA-FDD and GSM access technologies may include idle mode monitoring of system information sent on low rate broadcast channels. The WLAN access technology may be monitored with broadcast channels of 11 Mbps rate. IEEE 802.11b networks typically use 1 or 2 Mbps rate to broadcast beacon messages. RSSI measurements may be taken on broadcast channels. The measurements may be conducted in the receive chain circuitry. A service advisor apparatus may omit power control, ARQ (Automatic Repeat Request) for error control, data security functions, and channel multiplexing in case of WCDMA-FDD. In addition, for WCDMA-FDD and WLAN, a service advisor apparatus may implement only fixed spreading capability.

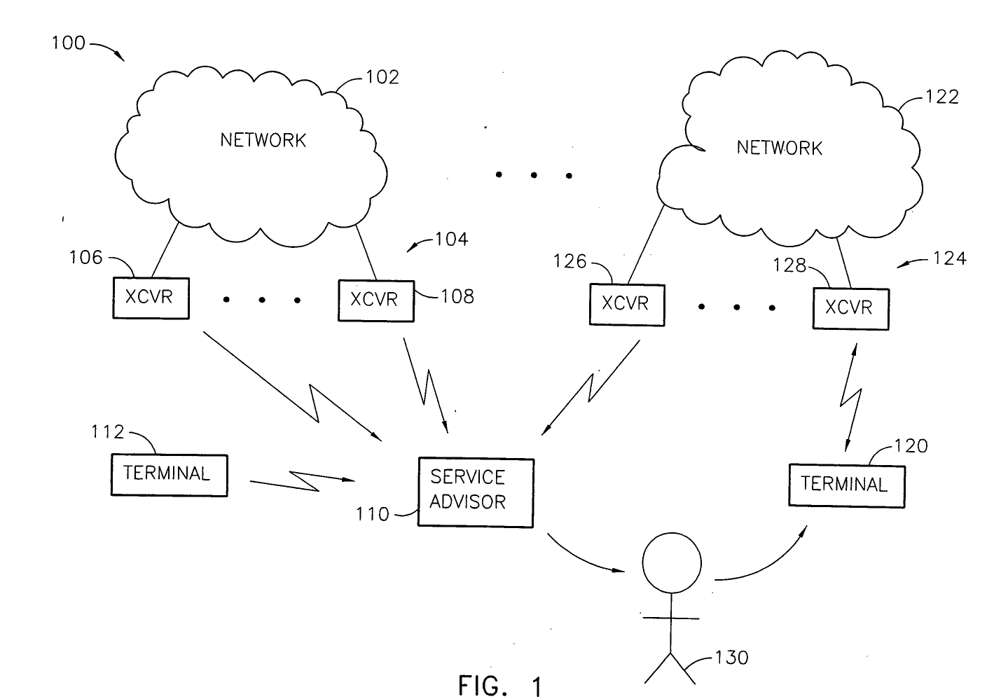

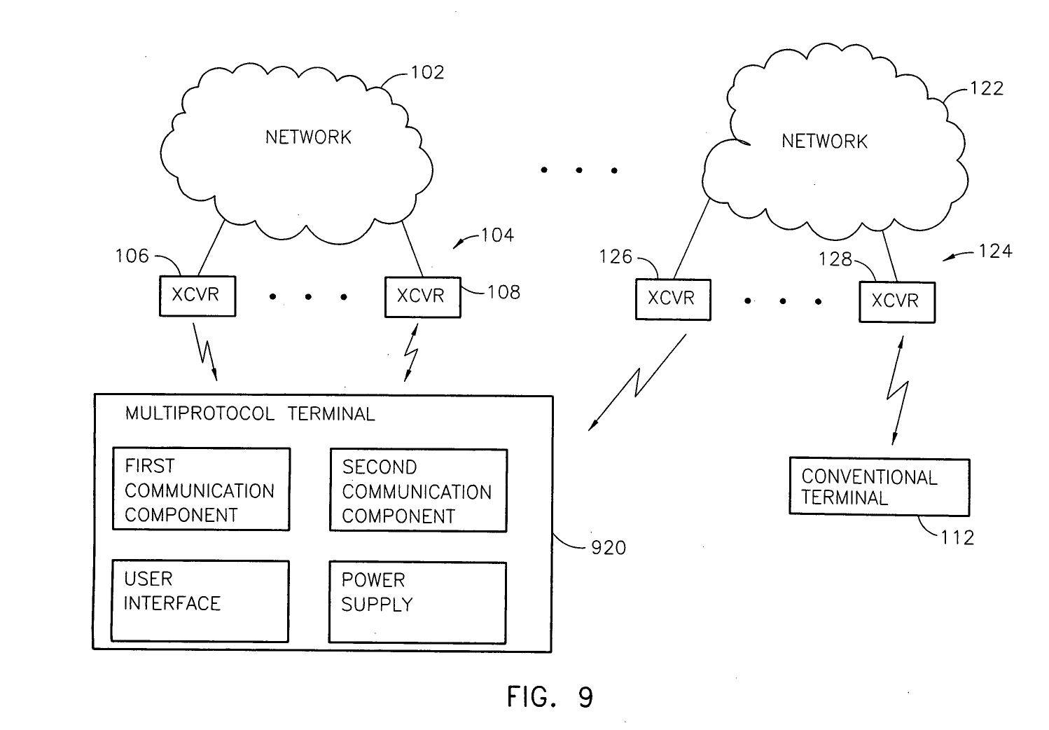

In general, apparatuses, systems, methods and computer program products according to various aspects of the present invention may be implemented in a multiprotocol terminal that monitors for an attempt to communicate using a first network (e.g., a first protocol) between a host (or application engine) of the multiprotocol terminal and a conventional terminal. Upon detecting the attempt to communicate using the first network, a link using a second network (e.g., a protocol different from the first protocol) may be initiated between the host and the conventional terminal. For example, communication as illustrated in FIG. 9 includes multiprotocol terminal 920 cooperating with numbered items discussed above with reference to FIG. 1.

A multiprotocol terminal according to various aspects of the present invention may include a conventional terminal as discussed above and further include a service advisor, a monitor, and a conventional bridge. For example, multiprotocol terminal 920 may include a mobile communication device/handset such as a cellular telephone, a digital cellular telephone, and/or a personal communication services (PCS) telephone.

Multiprotocol terminal 920 may comprise a first communication component adapted for communicating via a first communication network (e.g., network 122), such as a cellular communication network or cellular telephone communication network. Multiprotocol terminal 920 may further include a second communication component coupled to the first communication component. The second communication component may be adapted for communicating with a second network (e.g., network 102), such as a WLAN. In one implementation, a cellular communication component and a WLAN communication component may be integrated together, for example, in a common housing. In another implementation, the WLAN communication component may be detachably coupled to a cellular communication device that includes the cellular communication component. The WLAN component may be coupled to the cellular communication component via a peripheral interface of the multiprotocol terminal 920 such as, for example, a USB interface, a serial interface, a PCI interface, and/or a low rate interface (e.g., a IEEE 802.11 standard low rate interface).

Network 122 may comprise a Global System for Mobile Communications (GSM) network, a Time Division Multiple Access (TDMA) network, and/or a Code Division Multiple Access (CDMA) network.

Network 102 may comprise an Internet Protocol (IP) network capable of performing VoIP. Network 102 may also comprise a IEEE 802.11-standard and/or IEEE 802.15-standard compliant network. Network 102 may include one or more access points 104 through which at least wireless communication may occur between network 102 (and its members) and the WLAN communication component. Network 102 may be coupled to network 122 directly, via a Public Switched Telephone network (PSTN), and/or via a wide area network (WAN) (e.g., the Internet) so that network 102 may perform VoIP communication with the cellular communication network 122 and vice versa.

Multiprotocol terminal 920 may also include a user interface, as discussed above. For example, the user interface may comprise, for example, a touch sensitive input device (e.g., a keypad and/or a touch screen), a visual display, a ringer, a speaker, and a microphone. The keypad may include a plurality of alphanumeric keys for permitting the input by user of numbers, digits, letters, symbols, and/or commands into multiprotocol terminal 920. The WLAN communication component may be coupled to the user interface so that elements of the WLAN communication component may utilize the user interface including the microphone and speaker of multiprotocol terminal 920. In one implementation, the WLAN communication component may include its own microphone and speaker and/or an interface coupling a microphone and/or speaker thereto. In another implementation, the WLAN communication component may include logic capable of preventing the cellular communication component from receiving input from user interface of multiprotocol terminal 920. For example, the logic of the WLAN communication component may inhibit use of the speaker and microphone by the cellular communication component upon initiation of a communication via network 102.

Multiprotocol terminal 920 may includes a power supply (e.g., a battery) that provides power to the cellular communication component. In one implementation, the WLAN communication component may also be coupled to the power supply (either directly or via the cellular communication component).

The second communication component may be adapted for monitoring attempts to communicate by the first communication component (or vice versa). Attempts to communicate include an attempt to establish a communication link between the multiprotocol terminal 920 (e.g., via cellular communication component 102) and a conventional terminal 112 via network 122 (e.g., a cellular telephone network), for example, to service an incoming call or to implement an outgoing call. The second communication component may respond to a detection of such an attempt by initiating a communication with conventional terminal 112 via network 102 (e.g., using a Voice over Internet Protocol (VoIP)).

Multiprotocol terminal 920 may have a bus that may be monitored by a WLAN communication component to detect commands transmitted on the bus for controlling communication with a cellular communication network. In one implementation, the bus may comprise an AT bus and the commands transmitted on the bus may comprise AT commands of an AT command set. In one implementation, the AT commands transmitted via the bus may include a request for initiating a communication with a cellular communication network (e.g., 122).

The second communication component may include logic capable of converting sounds received from a microphone into data for conversion and inclusion into VoIP packets. The second communication component may also include logic capable of terminating attempts to establish a communication link via the cellular communication network 122 upon initiation of a communication via the WLAN network 102. The second communication component may further include logic capable of monitoring a proximate area to determine whether the second communication component is in a range for communicating with an access point 104. The second communication component may further include logic that generates a notice upon determining that the second communication component is in range of an access point.

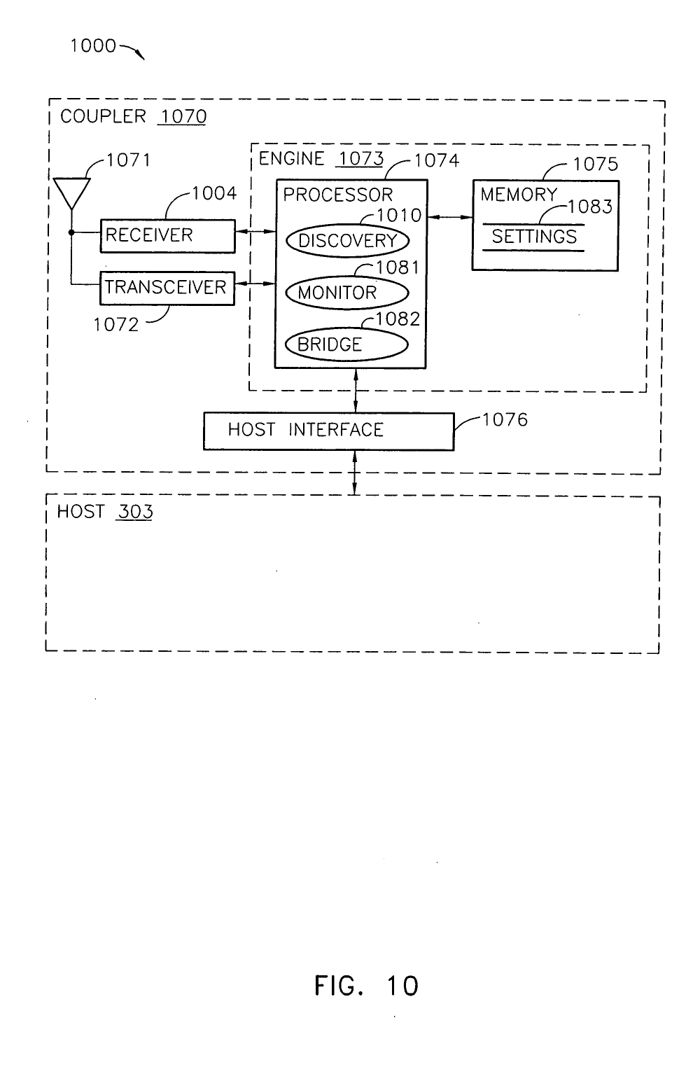

Multiprotocol terminal 920 may comprise a receiver for detecting services of networks 102 and 122, and a conventional dedicated terminal (e.g., of the type discussed with reference to terminal 112 of FIG. 9) for communication via one of these networks (e.g., network 122). For example, multiprotocol terminal 1000 of FIG. 10 includes coupler 1070 and host 303, as discussed above with reference to FIG. 3.

A coupler, according to various aspects of the present invention provides at least one of the following functions as a supplement to the functions of a conventional terminal. These functions include functions of a service advisor as discussed above (e.g., discovery of services, notification of available services), determining that a communication that would other wise use network 122 exclusively may be accomplished using a path that includes network 102 and 122, and functions of a bridge. For example, coupler 1070 includes receiver 1004, antenna 1071, transceiver 1072, engine 1073, and host interface 1076. Engine 1073 includes processor 1074 and memory 1075. Processor 1074 performs discovery process 1010, monitor process 1081, and bridge process 1082. In operation, host 303 communicates via its own transceiver with network 122; and host 303 communicates via coupler 1070 with network 102.

Antenna 1071, receiver 1004, and discovery process 1010 cooperate as discussed above with reference to antenna 302, receiver 304, and stack process 310. Discovery process 1010 detects and discovers the availability of services of network 102 and/or network 122 as discussed above with reference to a service advisor.

Transceiver 1072 cooperates with antenna 1071 in any suitable manner to communicate via network 102. Power for operation of transceiver 1072 may be limited until services of network 102 are detected and/or discovered.

Engine 1074 may be of the type described above with reference to engine 306 except as discussed below. Settings 1083 may include configuration values for use by processes 1010, 1081, and/or 1082. Host interface 1076 may include structures and functions as discussed above with reference to host interface 330, and further include capability supporting monitor process 1081 and bridge process 1082.

A monitor process, according to various aspects of the present invention, determines that a communication (e.g., intended in the future or on-going) between the multiprotocol terminal on which the monitor process is being performed and a network (e.g., used by the host for communication with terminal 112) may be implemented with a path that includes an additional different network (e.g., using a different protocol). Monitor process 1081 monitors operations between host interface 1076 and host 303 to determine that a communication via network 122 may be implemented through network 102 and network 122 as opposed to exclusively using network 122. In one implementation, command signals are monitored, such as AT commands as discussed above. Monitor process 1081 determines whether an attempt is being made (or is about to be made) by host 303 to communicate via network 122.

A bridge process performs as a conventional bridge between a member and a network and/or between different networks. Bridge process 1082 provides all suitable protocol translations to accomplish communication for network 122 that uses a path that includes network 102. Bridge 1082 may include a complete stack for each network, for example, a first stack for communicating with host 303 and a second stack for communicating with network 102. For efficiency, bridge functions of coupler 1070 associated with relatively lower level protocols may be implemented with circuitry of host interface 1076, processor 1082, and/or transceiver 1072 in cooperation with a bridge process for relatively higher level protocols (if any).

Transceiver 1072 may be omitted (with commensurate simplifications of coupler 1070) and communication via bridge process 1082 and network 102 facilitated instead by configuring transceiver 358 for use with network 102.

Receiver 1004 and discovery process 1010 may be omitted (with commensurate simplifications of coupler 1070) and the functions of a service advisor accomplished instead in any manner as discussed above.

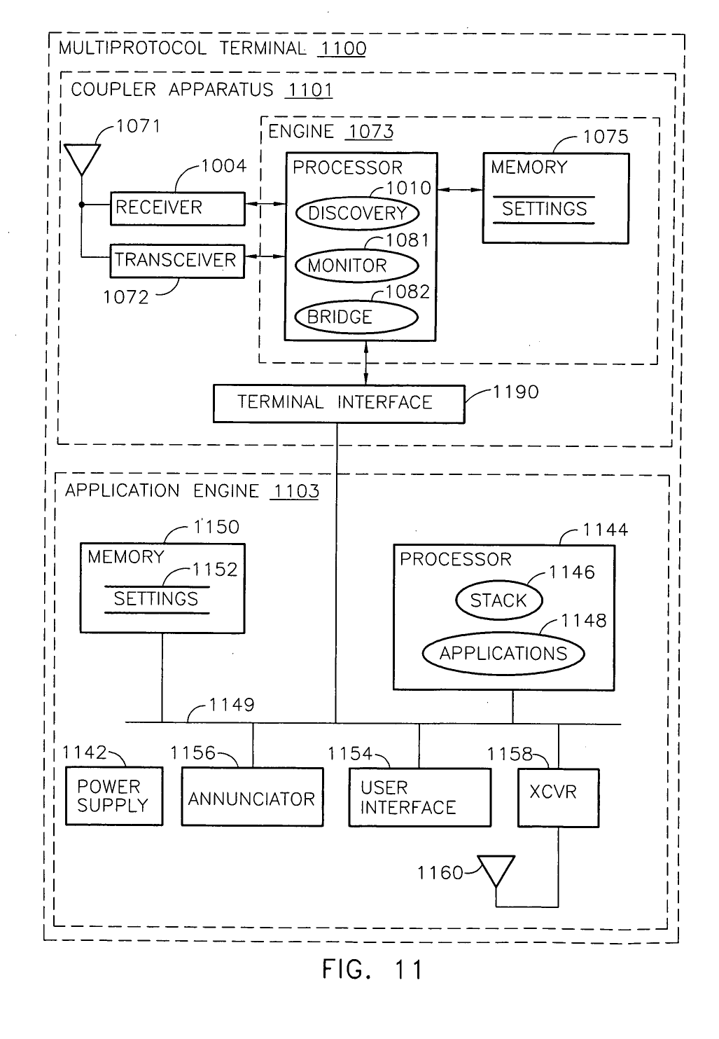

The functions of a coupler as discussed above may be integrated with a terminal (e.g., any conventional consumer electronics product), according to various aspects of the present invention. The terminal provides any one or more of a user interface, a power supply, an antenna, a receiver (e.g., for service detection), a processor (e.g., for coupler processes discussed above), and a transceiver (e.g., for different network communication); so that these functions may be omitted from the coupler apparatus. For example, multiprotocol terminal 1100 of FIG. 11 includes coupler apparatus 1101 and application engine 1103.

Coupler apparatus 1101 includes functions that may be implemented and operate in a manner similar to functions described with reference to FIGS. 3, 4, and 10 as follows: antenna 1071 (302, 402), receiver 1004 (304, 404), transceiver 1072, engine 1073, and terminal interface 1190 (430). Terminal interface 1190 may include the functions of terminal interface 430 and in addition facilitate communication as needed between processes performed by engine 1073 and structures and processes of application engine 1103. For example, monitor process 1081 and bridge process 1082 may cooperate with user I/O (1154) and transceiver 1158 via terminal interface 1190 to perform coupler functions as discussed above. For instance, terminal interface 1190 may include a serial interface for conventional AT commands as discussed above.

Application engine 1103 includes functions that may be implemented and operate in a manner similar to functions described with reference to FIGS. 4 and 10 as follows: memory 1150 (450), settings 1152 (452), processor 1144 (444), stack 1146 (446), applications 1148 (448), power supply 1142 (442), annunciator 1156 (456), user interface 1154 (454 and as discussed with reference to FIG. 9), transceiver 1158 (458), and antenna 1160 (460).

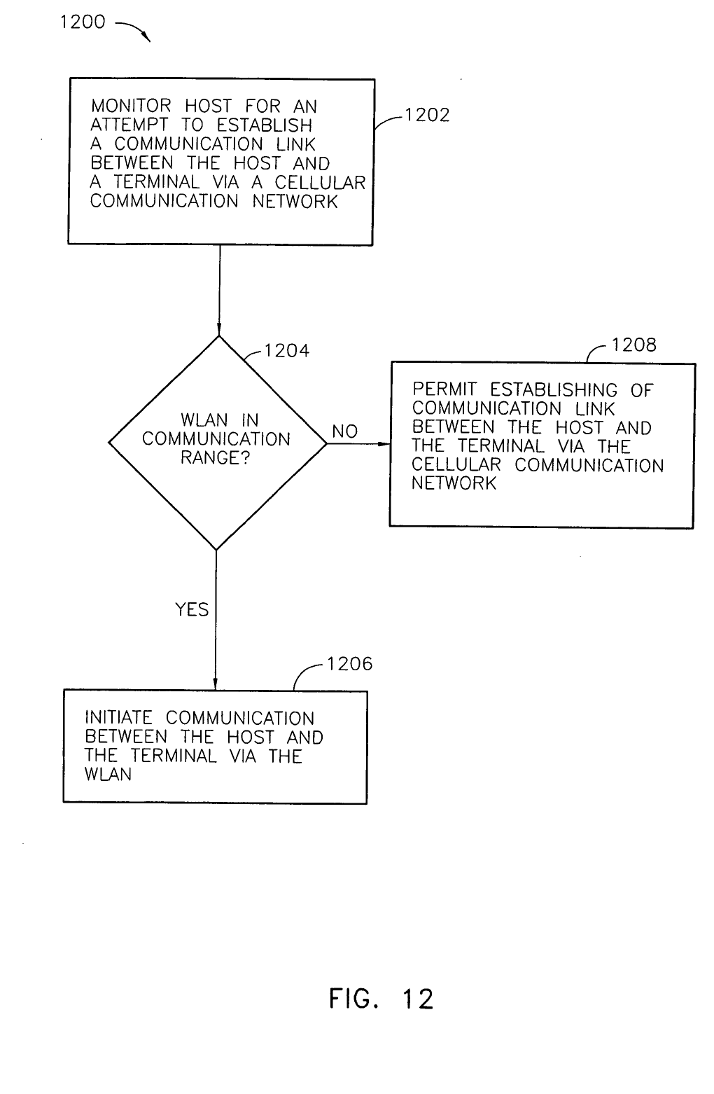

FIG. 12 is a flowchart illustrating a process 1200 performed by a multiprotocol terminal (e.g., 920 of FIG. 9) for communicating via a WLAN (e.g., 102) in accordance with an implementation of the present invention. In operation 1202, a host or application engine (303, 1103, collectively referred to as a host) may be monitored (e.g., by a coupler or coupler apparatus (collectively a coupler) having process 1081) for an attempt to communicate between the multiprotocol terminal and a conventional terminal (e.g., 112) via a cellular communication network (e.g., 122). Notices described below may be provided to a user of the host or to an application (collectively referred to as a user). Of course, any two dissimilar networks and/or protocols may be substituted with commensurate changes supporting those protocols.

An attempt to communicate includes a request to communicate (e.g., an incoming call is to be served or an outgoing call is to be placed), or a determination that desirable services are available for communication (e.g., a horizontal or vertical handover is available and desired). In one implementation, the host may initiate an attempt to establish a communication link via the cellular communication network (e.g., a phone call initiated by the host). In another implementation, a conventional terminal may initiate the attempt to establish a communication link via the cellular communication network (e.g., a phone call initiated by the conventional terminal). Establishing a link means obtaining cooperation at a desired level of the protocol stack. A lower level link may exist prior to establishing an upper level link, for example, to facilitate the attempt at an upper level link.

The monitoring of attempt(s) to establish a communication may be performed by the WLAN communication component discussed with reference to FIG. 9. Monitoring of the host may be accomplished by receiving a reply to commands issued to the host to determine whether an attempt is desired or in progress. For example, commands for controlling communication with the cellular communication network that are issued to one or more components of the host may be monitored to determine whether an attempt is being made. Such commands may be issued, for example, upon receipt of input from a user via a user interface of the host. In one implementation, a bus (1149) or interface (340) of the host may be monitored. The monitored commands may comprise AT commands of an AT command set that are transmitted over an AT command bus or interface of the host.

Conventional terminals (including the host) coupled to or capable of being coupled to the cellular communication network, the PSTN, and/or a WLAN are typically respectively identified by a unique identifier (e.g., a telephone number) so that communication with a particular conventional terminal may be initiated utilizing a particular identifier. Monitoring for an attempted communication may include detecting a telephone number associated with the host or conventional terminal (112) The telephone number may be included in one of the monitored commands issued by the coupler to the host.

In one implementation, at least one of the monitored commands may comprise a request for initiating a communication between the host and the conventional terminal (e.g., 112) via the WLAN (e.g., a command for initiating a telephone call between the host and the conventional terminal). In such an implementation, the command for initiating a communication may include a telephone number associated with the conventional terminal, a transmit command, and/or a send command. In another implementation, the request for initiating a communication may comprise a prefix and/or a suffix to the telephone number associated with the conventional terminal. In such an implementation, the prefix and/or suffix may be input by a user of the host via a user interface as discussed above. For example, the request may comprise a “#” symbol input by a user of the host either before or after input of a telephone number associated with the conventional terminal (112).

In decision 1204, a region surrounding the multiprotocol terminal may be monitored as discussed above with reference to processes 310 and 1010 to determined whether a VoIP service is available. For example, an indicator (e.g., a Server Side Include (SSI) scripting command) may be utilized to determine whether an in-range access point is capable of performing VoIP communication with the multiprotocol terminal. A service advisory notice as discussed above may be presented to the user (356, 1154, 1156) or to an application (348, 1148). The advisory (also herein called a notice) may include a visual element presented via a visual display of or coupled to (e.g., 1076, 1190) the coupler or the host. The notice may include an audible element generated by a speaker of or coupled to (e.g., 1076, 1190) the coupler or the host. The notice may indicate any one or more of the following: that an access point is in range; that the WLAN is capable of providing a VoIP service; that the WLAN has a VoIP service available; that the user is authorized to use the available VoIP service.

If an attempt to establish a communication link via the cellular communication network is detected and an access point of the WLAN is determined to be in communication range (and capable of VoIP communication), a communication via the WLAN may be initiated in operation 1206 between the multiprotocol terminal and the conventional terminal utilizing VoIP. The initiation of the communication via the WLAN may be performed by the WLAN communication component. The VoIP communication may be conducted using a session initiation protocol (SIP). The communication via the WLAN may be performed by extracting a voice stream (e.g., a Pulse Code Modulation (PCM) based voice stream) from a microphone circuit and/or a speaker circuit of the host. A further notice may be provided to the user (or application) about the availability, initiation, or current use of communication (e.g., automatic handover accomplished) via the WLAN. Notice may include an audible sound and/or a vibration generated by a speaker or a ringer component of the host.

In one implementation, upon the initiation of communication via the WLAN, the attempt to establish communication (or a link) via the cellular communication network may be terminated or abandoned. The communication over the cellular telephone network may be terminated before or after a communication link between the multiprotocol device and the conventional terminal is established via the cellular telephone network.

If the decision at 1204 is negative (e.g., no AP in range, no VoIP service available, no VoIP service authorized), then establishment of the communication link via the cellular communication network between the host and the conventional terminal (112) may be permitted 1208. Monitoring may loop to repeat decision 1204 for the duration of the communication (e.g., for horizontal and/or vertical handover).

A multiprotocol terminal may participate in communication of the type known as a conference call. For example, a first party may communicate via the host; a second party may communicate via the coupler; and any number of other parties may communicate via conventional terminals of conventional networks (e.g., 102, 112, PSTN, WAN). For another example, each party having a multiprotocol terminal may request to join the conference using conventional cellular communication and then transfer to the conference call implemented on the WLAN. After the WLAN communication component has been joined to the conference call, the link between the cellular communication component and the conventional terminal may be ended to leave only the VoIP link between the user (the WLAN communication component) and the WLAN conference.

Subsequent attempts to establish a communication link with the host via the cellular communication network (e.g., incoming calls to the host from the cellular communication network) may be prevented until the communication via the WLAN initiated in operation 1206 is ended. In such an implementation, further attempts to establish a communication link via the cellular communication network while the host is communicating with the conventional terminal via the WLAN may be directed to a voicemail box/account associated with the host and/or a user of the host. A notice may be generated to indicate the occurrence of the further attempts to establish a communication link with the host.

Functions of the type known as call-waiting may be implemented for communication via the multiprotocol terminal. During communication via the WLAN, the host may be monitored for subsequent attempts from the cellular communication network to establish a communication link with the host. A notice (e.g., an audible sound and/or a visual signal or message) may be generated to notify the user of the subsequent attempt(s) from the cellular communication network to establish a communication link with the host. A user may be permitted to selectively interrupt the original communication via the WLAN and establish a (e.g., temporary) new communication link via the cellular communication network in a manner similar to a conventional cellular phone call.

In accordance with the previously discussed aspects and features, in at least one implementation of the present invention voice calls may be diverted (Mobile Originating and Mobile Terminating) from licensed radio to be carried over unlicensed radio instead. For example, a coupler may be coupled to a conventional terminal (e.g., a communication device such as a cell phone or personal digital assistant (PDA)). The coupler may facilitate voice transmissions over WLAN and may monitor user actions over the terminal's user-interface by eavesdropping on commands being sent over the terminal's AT-bus to highjack the microphone or speaker for use over the WLAN connection. A terminal without voice capability (e.g., no microphone) may use the coupler to obtain VoIP services. The coupler may attach to the terminal for access to a serial interface for the AT-bus (e.g., a universal serial bus (USB)).

A coupler or coupler apparatus, according to various aspects of the present invention, may comprise a single-chip subsystem that includes WLAN IEEE 802.11 radio, baseband circuitry, MAC circuitry, and circuitry for other application protocols for supporting applications over WLAN. The coupler or coupler apparatus may be implemented for being plugged into a regular cellular phone (e.g. GSM, TDMA, and/or CDMA phone) having an accessory interface as discussed above. A headset having an earphone and/or a microphone may be plugged into the coupler or coupler apparatus. For example, the coupler or coupler apparatus may include a conventional southbridge. The southbridge may comprise a port or chip that controls I/O functions of the coupler, coupler apparatus, and/or host. The coupler or coupler apparatus may then use the headset for the source of audio-in and sink for audio-out for VoIP packets.

A coupler or coupler apparatus may receive its power from the host or application engine. The coupler may be packaged as a relatively small and compact accessory to a conventional host. Further, the keypad, address book, ringer, and/or other existing components and features of the host may be used by the coupler to for sophisticated discovery (1010) as discussed above with reference to a service advisor.

Due to the nature of packets carried over the WLAN interface, it may be sufficient to implement an IEEE 802.11 low rate interface. In such an implementation, high-speed functionality such as OFDM (Orthogonal Frequency Division Multiplexing) and other complex mechanisms typically used to achieve higher WLAN speeds may be omitted. By encoding VoIP packets using low-rate encoding solutions (e.g., G.729 or AMR), one voice channel may be carried over (e.g., 12 Kbps or less) a basic WLAN channel (e.g., IEEE 802.11).

If a cellular communication network operator (e.g., using GSM) blocks the capability to detect (1202) or initiate (1206) communication, a prefix or a suffix may be used with the telephone number. The prefix or suffix may be obtained by the coupler or coupler apparatus from an address book or user interface of the host.

A user may indicate to the coupler or coupler apparatus that use of the WLAN is desired. The user may so indicate using a prefix stored in an address book (e.g., a “phone book”) of the coupler (memory 1075) or the host. For example, if the user presses “*#” and then chooses a number in the user's address book, the coupler or coupler apparatus may hijack the call and place it over WLAN instead of a cellular communication network (e.g., GSM).

A coupler or coupler apparatus may extract a Pulse Code Modulation (PCM)-based voice stream by a variety of means, including, for example by hijacking the earphone and microphone of the cellular phone. If hijacking is not possible, the coupler or coupler apparatus may include a microphone and hijack the earphone of the host. If the host's resources are not available, the coupler may be plugged into the host and a regular headset may be plugged into the coupler, thus enabling the coupler to provide earphone and microphone facilities for WLAN-based communication. A coupler or coupler apparatus may provide a conventional southbridge interface to the headset.

For incoming calls via WLAN, a coupler or coupler apparatus may use host manufacturer enabled commands, such as AT-commands, to trigger ring signals on the host. If a WLAN phone call is connected, the coupler or coupler apparatus may monitor the AT-commands and when a GSM call comes in, abort either the WLAN call or the GSM call to avoid double connections being established. Communication between coupler and host may be based on AT commands as specified in the GSM 07.07 standard or equivalent for other standards. AT commands may enable the coupler or coupler apparatus to exercise control over the display and keypad of host. To this end, the following example AT commands may be utilized: Display control +CDIS, and Keypad control +CKPD. A Line selection command +VLS may be utilized to allow control on an internal speaker and microphone of the cellular phone 302. As for the phonebook, the AT-commands +CPBR, +CPBF and +CPBW may be used to read entries, find entries, and write an entry respectively.

A coupler or coupler apparatus (collectively a coupler) may be implemented with substantially a single chip architecture. For example, coupler 1300 has a single chip 1303 for VoIP on WLAN functions as discussed above with reference to FIGS. 1-12. Coupler 1300 may include an interface 1302 for coupling the single chip 1303 to a corresponding interface of a host to permit communication between the coupler and the host. Interface 1302 may also connect the coupler 1300 to a power supply of the host. Coupler 1300 may also include front-end RF components including WLAN receiver and transmitter paths 1304, 1306 coupled to an antenna 1308 via a switch 1310. In an exemplary implementation, receiver and transmitter paths may each include a bandpass filter 1312 and a balun 1314.

A coupler or coupler apparatus may be assigned an IP address from the WLAN. The coupler may register a user's conventional terminal (IP address) with a service provider coupled to the WLAN network. During the registration process, the user may be prompted for a unique identifier (e.g., a PIN code) for authenticating the user with the service provider.

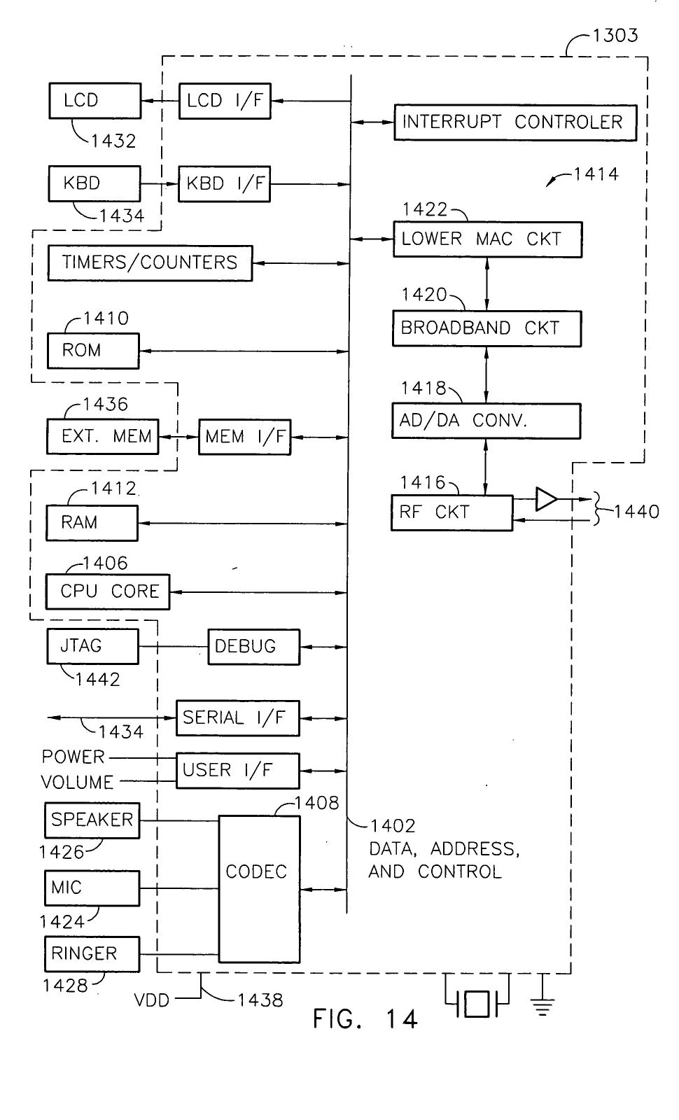

According to various aspects of the present invention, a coupler or coupler apparatus may use a single-chip for voice communication with conventional Session Initiation Protocol (SIP) or H323 protocol. For example, single chip 1303 may use the architecture illustrated in FIG. 14 for VoIP on WLAN as discussed above with reference to FIGS. 1-12. Single chip 1303 includes a plurality of components coupled to one or more buses 1402 such as a CPU core 1406 (e.g., a low power CPU core), a VoIP codec 1408, embedded memory 1410, 1412 (e.g., ROM 1410 and/or RAM 1412), an IEEE 802.11 WLAN physical layer interface 1414 and a plurality of special purpose interfaces.

The CPU core 1406 may comprise a low power CPU core. The CPU core 1406 may be used to run MAC software for controlling upper MAC operations and VoIP signaling and applications for controlling and managing the WLAN features of a coupler. The CPU core 1406 may also be utilized to run an SIP protocol stack (e.g., SIP/UDP/IP). The VoIP codec 1408 may comprise an application-specific digital signal processor (DSP). In one implementation, the IEEE 802.11 WLAN physical layer 1414 may include RF circuitry 1416, AD/DA converter(s) 1418, and baseband circuitry 1420. In one implementation, the architecture of the RF circuitry 1416 may be based on zero-IF and not involve any mixer steps to reduce the number of components in the RF circuitry 1416. The lower MAC operations that require real-time support (e.g. ACK generation) may also be implemented in circuitry 1422 to help reduce power consumption.

Special purpose interfaces may include an analog interface for coupling to a microphone 1424, a speaker 1426 and/or a ringer 1428. The interfaces may also include interfaces for coupling to a keypad 1434 and/or display 1432 (e.g., an LCD). Additional interfaces may be provided including serial interface(s), a UART interface, a USB interface, a JTAG interface 1442, a data/address interface to an external memory 1436, an interface for connecting to a power supply 1438, and interface(s) 1440 for front-end RF components.

A single-chip solution utilizing the exemplary architecture shown in FIG. 14 may support VoIP voice and instant messaging based on SIP/H323 and may support low rate data transfer of IEEE 802.11 WLAN (for example, 1 and 2 Mbit/sec). The single-chip implementation may also include an integrated VoIP codec to help minimize the number of external components. The single-chip implementation may also provide the capabilities of a full WLAN transceiver (including applications) and include full WLAN host/station (STA) functionality where the MAC, baseband RF, and the power amplifier are integrated into the same chip. The single-chip implementation 1303 may further provide a WLAN baseband solution that may use basic transmission rates of IEEE 802.11 and that may be adapted to minimize power consumption.

In accordance with an implementation of the present invention, the term “wireless” may refer to a communications, monitoring, or control system in which electromagnetic radiation spectrum or acoustic waves carry a signal through atmospheric space rather than along a wire. In most wireless systems, radio frequency (RF) or infrared transmission (IR) waves are used. Some monitoring devices, such as intrusion alarms, employ acoustic waves at frequencies above the range of human hearing. In wireless communications, cellular basically refers to the structure of the wireless transmission networks, such as American Mobile Phone Service (AMPS), which are comprised of geographic regions or transmission sites called cells. The term “cellular phone” may be used interchangeably with wireless phone or mobile communication device.

Time Division Multiple Access (TDMA) is an approach that converts audio signals into a stream of digital information and divides it into digital speech packets according to time. The packets are then transmitted one a single radio frequency. TDMA differs from CDMA in that it uses one channel instead of many. In TDMA, each cellular channel is divided into a number of time slots (i.e., multiplexed) in order to increase the amount of data that can be carried. TDMA is utilized in Digital-American Mobile Phone Service (D-AMPS), GSM, and Personal Digital Cellular (PDC). TDMA is implemented in each of these systems differently. In TDMA, the frequency band is split into a number of channels that are stacked into short time units so that several calls can share a single channel without interfering with one another. TDMA is also the name of a digital technology based on the IS-136 standard. TDMA is the current designation for what was formerly known as D-AMPS. See also IS-136 and D-AMPS.

Code Division Multiple Access (CDMA) is a spread spectrum approach for the digital transmission of data/voice over radio frequencies. In CDMA, sound bits are digitized and the data is split into data packets that are encoded with unique identification tags. All of the data/voice is sent over a spread range of radio frequencies. The cell phone or data device receives all of the data packets, re-assembles the packets with the correct code, and transforms the data contained in the reassembled packets into sound and data. In CDMA, an entire allocated frequency range for a given service and multiplexes information for all users is multiplexed at the same time across an entire allocated frequency range for a given service.

A Global System for Mobile communications (GSM) network is a digital cellular or PCS network based on TDMA. A GSM phone receives a Subscriber Identity Module (SIM) smart card that contains user account information. A GSM phone becomes programmed with the user account information after coupling to the SIM card. Personal Communications Service (PCS) refers to wireless, voice and/or data communications systems, typically incorporating digital technology. PCS systems use a different radio frequency (the 1.9 GHz (1900 MHz) band) than cellular phones and generally use digital technology for transmission and reception. PCS typically bundles voice communications, numeric and text messaging, voice mail and other features into one device or service. 3rd Generation Partnership Project (3GPP) specifications standardize mobile communications based on GSM core networks and UTRA radio access.

IEEE 802.15 is the standard for wireless personal area networks (PANs) and includes specifications for the Bluetooth standard. Bluetooth is a standard for wireless transmission of voice and data between mobile devices (PCs, handheld computers, telephone and printers.) The Bluetooth standard calls for different profiles such as voice and serial emulation to be used by devices to communicate. IEEE 802.11 is the IEEE standard for wireless local area networks/WLANs. IEEE 802.11 defines both the Physical (PHY) and (Ethernet) Medium Access Control (MAC) protocols for wireless local area networks/WLANs. The physical layer covers diffused infrared, direct sequence and frequency-hopping spread spectrum transmissions. IEEE 802.11 accommodates the use of Wired Equivalent Privacy (WEP), a wireless authentication protocol based on I.D. keys and bit-encryption. Wi-Fi (short for “wireless fidelity”) is a high-frequency wireless local area network (WLAN). The Wi-Fi technology may be used as an alternative to a wired LAN. Wi-Fi technology may also be installed for a home network. Wi-Fi is specified in the 802.11b specification from the Institute of Electrical and Electronics Engineers (IEEE) and is part of a series of wireless specifications together with 802.11, 802.11a, and 802.11g. All four standards use the Ethernet protocol and CSMA/CA (carrier sense multiple access with collision avoidance) for path sharing. The 802.11b (Wi-Fi) technology operates in the 2.4 GHz range offering data speeds up to 11 megabits per second. The modulation used in 802.11 may be (and has historically been) phase-shift keying (PSK). The modulation method selected for 802.11b is known as complementary code keying (CCK), which allows higher data speeds and is less susceptible to multipath-propagation interference.

Unless adequately protected, a Wi-Fi wireless LAN may be susceptible to access from the outside by unauthorized users, some of whom have used the access as a free Internet connection. Some exemplary security safeguards that may be implemented to protect a Wi-Fi wireless LAN include, for example, the Wired Equivalent Privacy (WEP) encryption standard, the setup and use of a virtual private network (VPN) or IPsec, and a firewall or DMZ. The Wired Equivalent Privacy (WEP) algorithm, is part of the 802.11 standard. The 802.11 standard describes the communication that occurs in WLANs. The WEP algorithm is used to protect wireless communication from eavesdropping. A secondary function of WEP is to prevent unauthorized access to a wireless network WEP relies on a secret key that is shared between a mobile station (e.g. a laptop with a wireless Ethernet card) and an access point (i.e. a base station). The secret key is used to encrypt packets before they are transmitted, and an integrity check is used to ensure that packets are not modified in transit. Data encryption may be utilized to protect the vulnerable wireless link between clients and access points. Once such a measure has been taken, other LAN security mechanisms such as, for example, password protection, end-to-end encryption, virtual private networks (VPNs), and authentication may be utilized to help ensure privacy. Wireless Transport Layer Security (WTLS) is the security level for Wireless Application Protocol (WAP) applications. A virtual private network (VPN) is a private data network that makes use of the public telecommunication infrastructure, maintaining privacy through the use of a tunneling protocol and security procedures. Using a virtual private network involves encryption data before sending it through the public network and decrypting it at the receiving end. An additional level of security involves encrypting not only the data but also the originating and receiving network addresses.

Transmission Control Protocol/Internet Protocol (TCP/IP) is a basic communication language or protocol of the Internet. It may be used as a communications protocol in the private networks called intranet and in extranet. TCP/IP is a two-layering program. The higher layer, Transmission Control Protocol (TCP), manages the assembling of a message or file into smaller packet that are transmitted over the Internet and received by a TCP layer that reassembles the packets into the original message. The lower layer, Internet Protocol (IP), handles the address part of each packet so that it gets to the right destination. Each gateway computer on the network checks this address to see where to forward the message. Even though some packets from the same message are routed differently than others, they'll be reassembled at the destination. TCP/IP may use a client/server model of communication in which a computer user (a client) requests and is provided a service (such as sending a Web page) by another computer (a server) in the network. TCP/IP communication is primarily point-to-point, meaning each communication is from one point (or host computer) in the network to another point or host computer. TCP/IP and the higher-level applications that use it are collectively said to be “stateless” because each client request is considered a new request unrelated to any previous one (unlike ordinary phone conversations that require a dedicated connection for the call duration). Being stateless frees network paths so that everyone can use them continuously. (Note that the TCP layer itself is not stateless as far as any one message is concerned. Its connection remains in place until all packets in a message have been received.). Protocols related to TCP/IP include the User Datagram Protocol (UDP), which is used instead of TCP for special purposes. Other protocols are used by network host computers for exchanging router information. These include the Internet Control Message Protocol (ICMP), the Interior Gateway Protocol (IGP), the Exterior Gateway Protocol (EGP), and the Border Gateway Protocol (BGP).

Internet Protocol (IP) telephony is a general term for the technologies that use the Internet Protocol's packet-switched connections to exchange voice, fax, and other forms of information that have traditionally been carried over the dedicated circuit-switched connections of the public switched telephone network (PSTN). VoIP may be used to perform IP telephony. Using VoIP, voice information may be sent in digital form in discrete packets rather than in the traditional circuit-committed protocols of a PSTN. VoIP may use the ITU-T H.323 standard for sending voice (audio) and video using IP on the public Internet and within an intranet. In addition to IP, VoIP may use the real-time protocol (RTP) to help ensure that packets get delivered in a timely way.

H.323 is an International Telecommunication Union (ITU-T) standard that defines a protocol for the transmission of real-time audio, video and data information (i.e., multimedia communications) over packet switching-based networks. H.323 may be applied to multipoint-multimedia communications. Session Initiation Protocol (SIP) is an IETF signaling protocol set forth in RFC 2543 for establishing real-time calls and conferences over Internet Protocol networks. Each session may include different types of data such as audio and video. As a traditional text-based Internet protocol, it resembles the hypertext transfer protocol (HTTP) and simple mail transfer protocol (SMTP). SIP uses Session Description Protocol (SDP) for media description. SIP is independent of the packet layer. SIP may be utilized for Internet telephony signaling, in gateways, PC phones, softswitches, and softphones, but is not necessarily limited to Internet telephony, and may be used to initiate and manage other types of sessions including, for example, video, interactive games, and text messaging. Both SIP and H.323 define mechanisms for call routing, call signaling, capabilities exchange, media control, and supplementary services.

Server Side Include (SSI) is a type of HTML comment that directs the Web server to dynamically generate/create data. SSIs afford an ability to include files from a server inside an HTML file by placing tags in the HTML file that link to the associated server-side files. SSIs may also be used to execute programs and insert the results of that program into a file. Using SSIs helps to avoid including multiple copies of the same information in an HTML file and helps make it easier to work with frequently-updated information.

AT commands are commands issued to a modem for setting parameters, such as protocol usage, connections speeds, etc. The AT comes from “attention” because AT is usually entered immediately before any other commands/settings to first get the “attention” of the modem, telling it that it's about to receive commands. AT commands were originally developed by Hayes.

In telecommunications, a codec (i.e., coder-decoder) is a device that encodes or decodes a signal. A codec may use analog-to-digital conversion and digital-to-analog conversion. In this context, a codec may be used to convert analog signals such as video or voice into digital form for transmission over digital medium and, upon reception, reconverts the signals to the original analog form. A codec cay also perform other signal processing functions. In another implementation, a codec may refer to a compressor/decompressor which compresses and decompresses data. Codecs may be implemented in software, hardware, or a combination of both.

In general, Medium Access Control (MAC), is the lower of two sub-layers of a data link layer that defines topology dependent access control protocols including framing and error detection. In a WLAN, Medium Access Control (MAC) is a radio controller protocol that corresponds to the ISO Network Model's level 2 Data Link layer. The IEEE 802.11 standard specifies the MAC protocol for medium sharing, packets formats and addressing, and error detection.

A bandpass filter (BPF) is an analog or digital audio device that passes a specific band of frequencies and rejects frequencies both above and below the pass band. In other words, a BPF allows a continuous range of frequencies to pass, while attenuating frequencies which are both above and below that range. A balun is an impedance matching transformer that converts the impedance of one interface to the impedance of another interface. A balun may be used to connect one type of cabling to another, for example, balanced twisted pair cabling with unbalanced coaxial cabling. Joint Test Action Group (JTAG) refers to the IEEE 1149.1 Standard that defines a four-pin interface designed to test connections between chips.

Pulse Code Modulation (PCM) is a technique for converting analog signals to a digital representation. More specifically, Pulse Code Modulation is a signal encoding technique/algorithm for encoding an audio signal in digital format through modulation of a carrier pulse width. The PCM audio encoding algorithm encodes the amplitude of a repetitive series of audio samples with a fixed number of bits. This encoding algorithm converts analog voice samples into a digital bit stream. PCM may e used with T-1 and T-3 carrier systems. These carrier systems may combine the PCM signals from many lines and transmit them over a single cable or other medium. In Pulse Code Modulation, audio data is encoded as a series of pulses. Each pulse defines a transition from binary one to binary zero.

In an implementation of the present invention, various sub-components of each of component may also be considered components of the system. For example, particular software modules executed on any component of the system may also be considered components of the system. Components of implementations of the present invention may be implemented on computers having a central processing unit such as a microprocessor, and a number of other units interconnected via a bus. Such computers may also include Random Access Memory (RAM), Read Only Memory (ROM), an I/O adapter for connecting peripheral devices such as, for example, disk storage units and printers to the bus, a user interface adapter for connecting various user interface devices such as, for example, a keyboard, a mouse, a speaker, a microphone, and/or other user interface devices such as a touch screen or a digital camera to the bus, a communication adapter for connecting the workstation to a communication network (e.g., a data processing network) and a display adapter for connecting the bus to a display device. The workstation may utilize an operating system such as, for example, a Microsoft Windows Operating System (OS), a Macintosh OS, a Linux OS and/or a UNIX OS. Those skilled in the art will appreciate that the present invention may also be implemented on platforms and operating systems other than those mentioned. Implementations of the present invention may also be implemented using computer program languages such as, for example, ActiveX, Java, C, and the C++ language and utilize object oriented programming methodology.

Based on the foregoing specification, the invention may be implemented using computer programming or engineering techniques including computer software, firmware, hardware or any combination or subset thereof. Any such resulting program, having computer-readable code means, may be embodied or provided within one or more computer-readable media, thereby making a computer program product, i.e., an article of manufacture, according to the invention. The computer readable media may be, for instance, a fixed (hard) drive, diskette, optical disk, magnetic tape, semiconductor memory such as read-only memory (ROM), etc., or any transmitting/receiving medium such as the Internet or other communication network or link. The article of manufacture containing the computer code may be made and/or used by executing the code directly from one medium, by copying the code from one medium to another medium, or by transmitting the code over a network.

Unless contrary to physical possibility, the inventor envisions the methods described herein may be performed in any sequence and/or combination. The foregoing description discusses preferred embodiments of the present invention which may be changed or modified without departing from the scope of the present invention as defined in the claims. While for the sake of clarity of description, several specific embodiments of the invention have been described, the scope of the invention is intended to be measured by the claims as set forth below.

1. A coupler for use with a provided terminal, the terminal being operative with a first network, the coupler comprising:
monitor means for monitoring the terminal to detect communication suitable for a second network;
bridge means for conveying the communication via a second network having a protocol not used with the first network.

2. The coupler of claim 1 further comprising service advisory means for detecting whether the second network is available as a prerequisite to conveying the communication via the second network.

3. The coupler of claim 1 further comprising service advisory means for detecting whether a service of the second network is available as a prerequisite to conveying the communication via the second network.

4. The coupler of claim 1 further comprising service advisory means for detecting whether a service of the second network is authorized for use as a prerequisite to conveying the communication via the second network.

5. The coupler of claim 1 wherein the bridge means comprises a transceiver operative in a first mode before availability of the service is determined by the service advisory means and in a second mode thereafter, the first mode consuming less power than the second mode.

6. A multiprotocol terminal comprising the terminal removably coupled to the coupler of claim 1.

7. A multiprotocol terminal comprising a housing, an application engine, and the coupler of claim 1, the application engine and the coupler packaged within the housing.

8. The coupler of claim 1 wherein circuitry for communication with the terminal in a protocol of the first network and for communicating with a protocol of the second network is formed on one substrate.

9. A method for multiprotocol communication, the method performed by a processor of a terminal, the method comprising:
monitoring a host or application engine coupled of the terminal for an attempt to communicate or on-going communication via a first network;
determining whether a second network is available; and
accomplishing communication for the host or application engine via the second network.

10. The method of claim 9 wherein monitoring comprises analysis of a signal provided by the host or application engine in response to a command by the processor.

11. The method of claim 9 wherein monitoring comprises detecting a signal provided by the host or application engine in the form of an AT command or response.

12. The method of claim 9 wherein the attempt comprises an incoming telephone call.

13. The method of claim 9 wherein the attempt comprises an outgoing telephone call.

14. The method of claim 9 wherein the attempt comprises continued communication suitable for a desired handover.

15. The method of claim 9 further comprising determining that the attempt is suitable for communication via the second network with reference to contents of a memory of the terminal.

16. The method of claim 9 further comprising determining that the attempt is suitable for communication via the second network with reference to data input by a user of the terminal prior to the attempt.

17. The method of claim 9 further comprising enabling communication via the second network in accordance with a command entered by the user of the terminal.
